(19) United States
(12) Patent Application Publication
(10) Pub. No.: US 2019/0037635 A1
(43) Pub. Date: Jan. 31, 2019

(54) METHOD AND APPARATUS OF RECOVERING RRC CONNECTION IN A WIRELESS COMMUNICATION SYSTEM

(71) Applicant: ASUSTek Computer Inc., Taipei City (TW)

(72) Inventors: Yu-Hsuan Guo, Taipei City (TW); Li-Te Pan, Taipei City (TW)

(21) Appl. No.: 16/041,448

(22) Filed: Jul. 20, 2018

Related U.S. Application Data
(60) Provisional application No. 62/538,580, filed on Jul. 28, 2017.

(51) Int. Cl. H04W 76/27

(52) U.S. Cl. CPC H04W 76/27; H04W 88/02

(57) ABSTRACT

Methods and apparatuses for recovering a Radio Resource Control (RRC) connection in a wireless communication system are disclosed herein. In one method, a user equipment (UE) performs a procedure used to re-establish a RRC connection between the UE and a network node. The UE enters a RRC_INACTIVE state when the procedure is failed and if the UE has at least one parameter of the RRC_INACTIVE state. The UE enters a RRC_IDLE state when the procedure is failed and if the UE does not have the at least one parameter of the RRC_INACTIVE state.

### CROSS-REFERENCE TO RELATED APPLICATIONS

The present application claims the benefit of U.S. Provisional Patent Application Ser. No. 62/538,580 filed on Jul. 28, 2017, the entire disclosure of which is incorporated herein in its entirety by reference.

### FIELD

This disclosure generally relates to wireless communication networks, and more particularly, to a method and apparatus of recovering RRC connection in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods and apparatuses for recovering a Radio Resource Control (RRC) connection in a wireless communication system are disclosed herein. In one method, a user equipment (UE) performs a procedure used to re-establish a RRC connection between the UE and a network node. The UE enters a RRC_INACTIVE state when the procedure is failed and if the UE has at least one parameter of the RRC_INACTIVE state. The UE enters a RRC_IDLE state when the procedure is failed and if the UE does not have the at least one parameter of the RRC_INACTIVE state.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 9.2.2.4.1-1 taken from 3GPP TS 38.300 v0.4.1 illustrating a UE triggered transition from RRC_INACTIVE to RRC_ACTIVE.

FIG. 6 is a reproduction of FIG. 9.2.2.4.2-1 taken from 3GPP TS 38.300 v0.4.1 illustrating a network triggered transition from RRC_INACTIVE to RRC_CONNECTED.

FIG. 7 is a reproduction of FIG. 9.2.3-1 taken from 3GPP TS 38.300 v0.4.1 illustrating Inter-gNB handover procedures.

FIG. 8 is a reproduction of FIG. 9.2.3.2.1-1 taken from 3GPP TS 38.300 v0.4.1 illustrating Intra-AMF/UPF Handover.

FIG. 9 is a reproduction of FIG. 19.2.2.3-1 taken from 3GPP TS36.300 v14.2.0 illustrating Initial Context Setup procedure in Idle-to-Active procedure.

FIG. 10 is a reproduction of FIG. 5.3.3.1-3 taken from 3GPP TS36.331 v14.2.1 illustrating RRC connection resume, successful.

FIG. 11 is a reproduction of FIG. 5.3.3.1-4 taken from 3GPP TS36.331 v14.2.1 illustrating RRC connection resume fallback to RRC connection establishment, successful.

FIG. 12 is a reproduction of FIG. 5.3.3.1-5 taken from 3GPP TS36.331 v14.2.1 illustrating RRC connection resume, network reject or release.

FIG. 13 is a reproduction of FIG. 5.3.7.1-1 taken from 3GPP TS36.331 v14.2.1 illustrating RRC connection re-establishment, successful.

FIG. 14 is a reproduction of FIG. 5.3.7.1-2 taken from 3GPP TS36.331 v14.2.1 illustrating RRC connection re-establishment, failure.

FIG. 15 is a reproduction of FIG. 5.3.8.1-1 taken from 3GPP TS36.331 v14.2.1 illustrating RRC connection release, successful.

FIG. 16 is a reproduction of FIG. 10.1.2.1.1-1 taken from 3GPP TS36.300 v14.2.0 illustrating Intra-MME/Serving Gateway HO.

FIG. 17 is a flow chart illustrating an issue with current procedures used to re-establish a RRC connection .

FIG. 18 illustrates a flow chart of one exemplary embodiment.

FIG. 19 illustrates a flow chart of one exemplary embodiment.

FIG. 20 is a flow diagram for one exemplary embodiment from the perspective of a UE.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems devices described below may be designed to support one or more standards such as the standard offered by a consortium named “3rd Generation Partnership Project” referred to herein as 3GPP, including: TS38.300 v0.4.1, NR; NR and NG-RAN Overall Description, Stage 2; TS36.300 v14.2.0, Evolved Universal Terrestrial Radio Access (E-UTRA) and Evolved Universal Terrestrial Radio Access Network (E-UTRAN); Overall Description, Stage 2; R2-1706723, State transition between RRC_CONNECTED and INACTIVE; TS38.321 v0.0.3, NR; Medium Access Control (MAC) protocol specification; TS38.323 v0.0.5, NR; Packet Data Convergence Protocol (PDCP) specification; TS36.331 v14.2.1, Evolved Universal Terrestrial Radio Access (E-UTRA); Radio Resource Control (RRC), Protocol specification; TS36.304 v14.3.0, Evolved Universal Terrestrial Radio Access (E-UTRA) and Evolved Universal Terrestrial Radio Access Network (E-UTRAN); User Equipment (UE) procedures in idle mode; and RAN2#101bis Chairman's notes. The standards and documents listed above are hereby expressly incorporated by reference in their entirety.

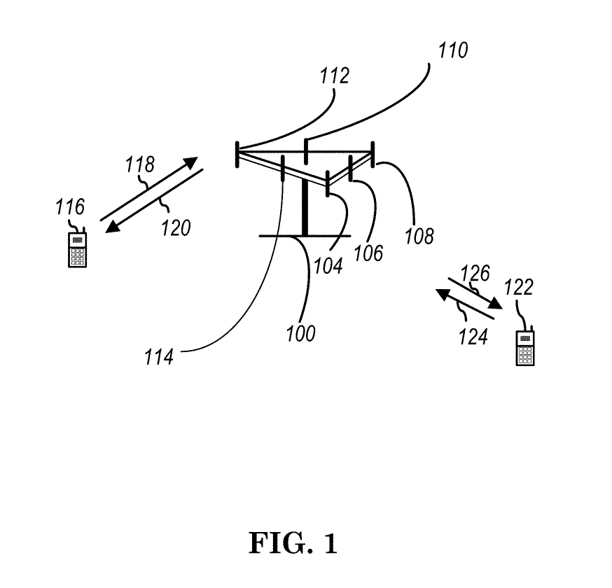

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

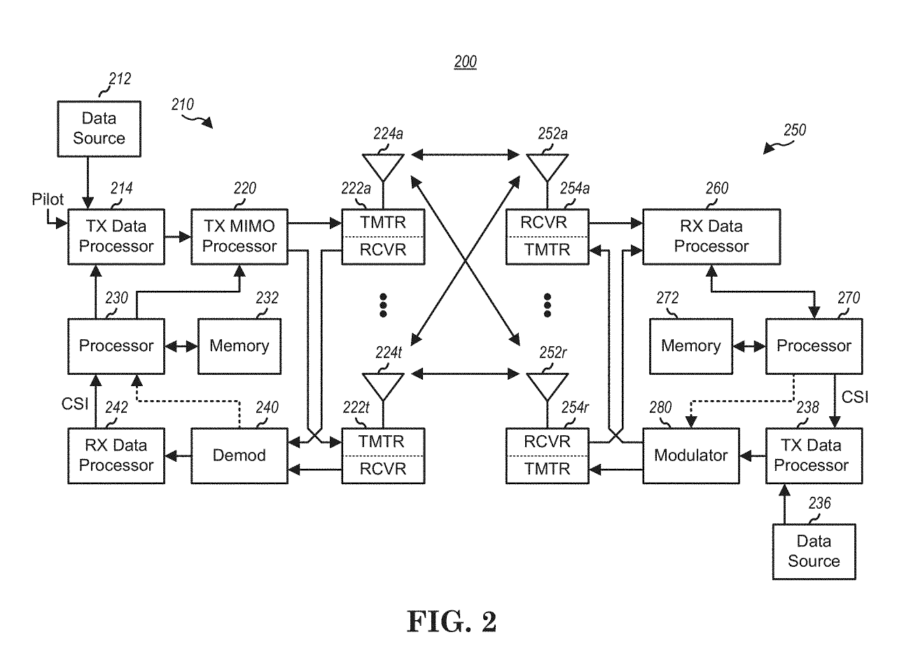

FIG. 2 is a simplified block diagram of an embodiment of a transmitter system 210 (also known as the access network) and a receiver system 250 (also known as access terminal (AT) or user equipment (UE) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

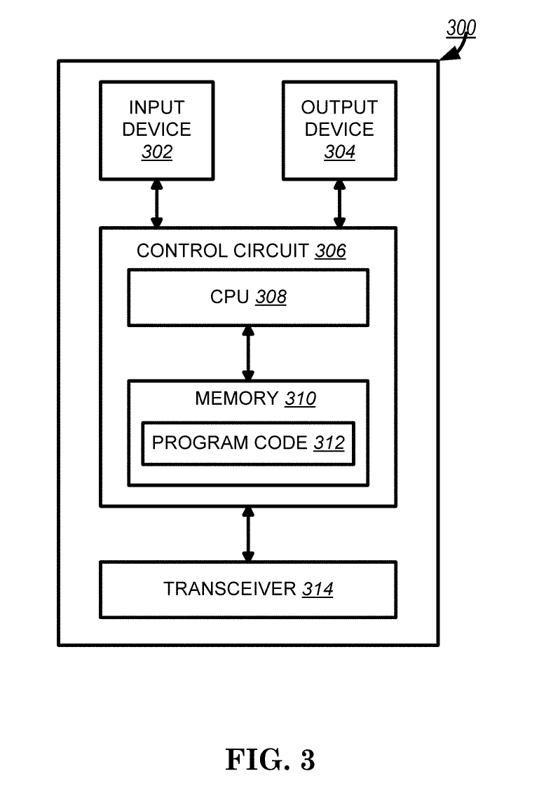

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

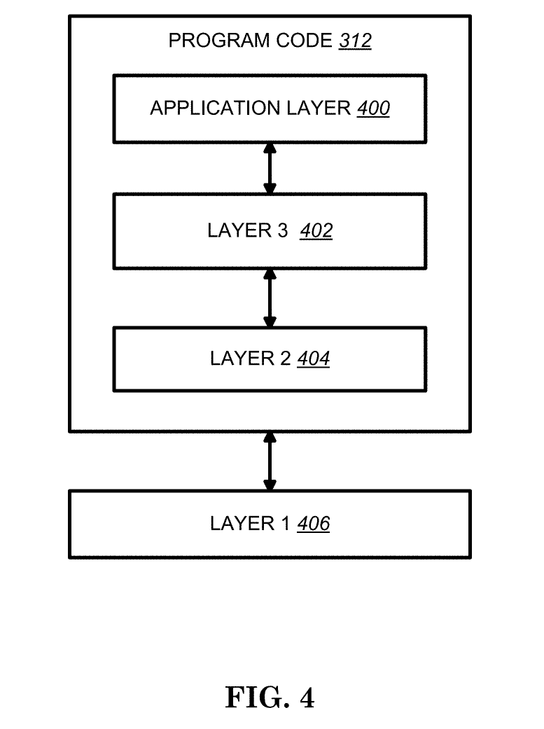

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR system, the Layer 2 portion 404 may include a Radio Link Control (RLC) layer and a Medium Access Control (MAC) layer. The Layer 3 portion 402 may include a Radio Resource Control (RRC) layer.

3GPP TS 38.300 v0.4.1 introduces RRC states as quoted below:

### 7.2 Protocol States

RRC supports the following states which can be characterised as follows:
RRC_IDLE:
   PLMN selection;
   Broadcast of system information;
   Cell re-selection mobility;
   Paging (initiated and area managed by 5GC);
   DRX for CN paging configured by NAS.

FFS whether the UE AS context is not stored in any gNB or in the UE.
RRC_INACTIVE:
   Broadcast of system information;
   Cell re-selection mobility;
   5GC-NG-RAN connection (both C/U-planes) is established for UE;
   The UE AS context is stored in at least one gNB and the UE;
   Paging is initiated by NG-RAN;
   DRX for NG-RAN paging configured by NG-RAN;
   RAN-based notification area (RNA) is managed by NG- RAN;
   NG-RAN knows the RAN-based notification area which the UE belongs to;

FFS if data transmission in possible in INACTIVE. FFS if PLMN selection is supported in INACTIVE.
RRC_CONNECTED:
   The UE has an NG-RAN RRC connection;
   The UE has an AS context in NG-RAN;
   NG-RAN knows the cell which the UE belongs to;
   Transfer of unicast data to/from the UE;
   Network controlled mobility including measurements.

3GPP TS 38.300 introduces mobility in RRC_INACTIVE and RRC_CONNECTED as quoted below:

### 9.2.2 Mobility in RRC_INACTIVE

### 9.2.2.1 Overview

RRC_INACTIVE is a state where a UE remains in CM-CONNECTED and can move within an area configured by NG-RAN (the RNA) without notifying NG-RAN. In RRC_INACTIVE, the last serving NG-RAN node keeps the UE context and the UE-associated NG connection with the serving AMF and UPF. The UE notifies the network if it moves out of the configured RNA.

If the last serving NG-RAN node receives DL data from the UPF or DL signalling from the AMF while the UE is in RRC_INACTIVE, it pages in the cells corresponding to the RNA and may send Xn-AP RAN Paging to neighbour NG-RAN node(s) if the RNA includes cells of neighbour NG-RAN node(s).

FFS whether upon RAN paging failure, the last serving NG-RAN node shall release the NG connection of the UE.

If the UE accesses an NG-RAN node other than the last serving NG-RAN node, the receiving NG-RAN node triggers the Xn-AP Retrieve UE Context procedure to get the UE context from the last serving NG-RAN node and may also trigger a Data Forwarding procedure including tunnel information for potential recovery of data from the last serving NG-RAN node. Upon successful context retrieval, the receiving NG-RAN node becomes the new serving NG-RAN node and it further triggers the NG-AP Path Switch Request procedure. After the path switch procedure, the NG-RAN node triggers release of the UE context at the old NG-RAN node by means of the Xn-AP UE Context Release procedure.

### 9.2.2.2 Cell Reselection

Can we assume the same principle as for RRC-IDLE?

### 9.2.2.3 RAN-Based Notification Area

A UE in the RRC_INACTIVE state can be configured with an RNA, where:
the RNA can cover a single or multiple cells, and can be smaller than CN area;
a RAN-based location area update (RLAU) is periodically sent by the UE and is also sent when the cell reselection procedure of the UE selects a cell that does not belong to the configured RNA.

There are several different alternatives on how the RNA can be configured:
List of cells:
   A UE is provided an explicit list of cells (one or more) that constitute the RNA.
RAN area:
   A UE is provided (at least one) RAN area ID;
   A cell broadcasts (at least one) RAN area ID in the system information so that a UE knows which area the cell belongs to.

FFS whether one alternative or both are agreed.

### 9.2.2.4 State Transitions

9.2.2.4.1 UE triggered transition from RRC_INACTIVE to RRC_ACTIVE

Editor's Note: some general text to be provided, mainly from RAN3. RRC signalling is FFS.

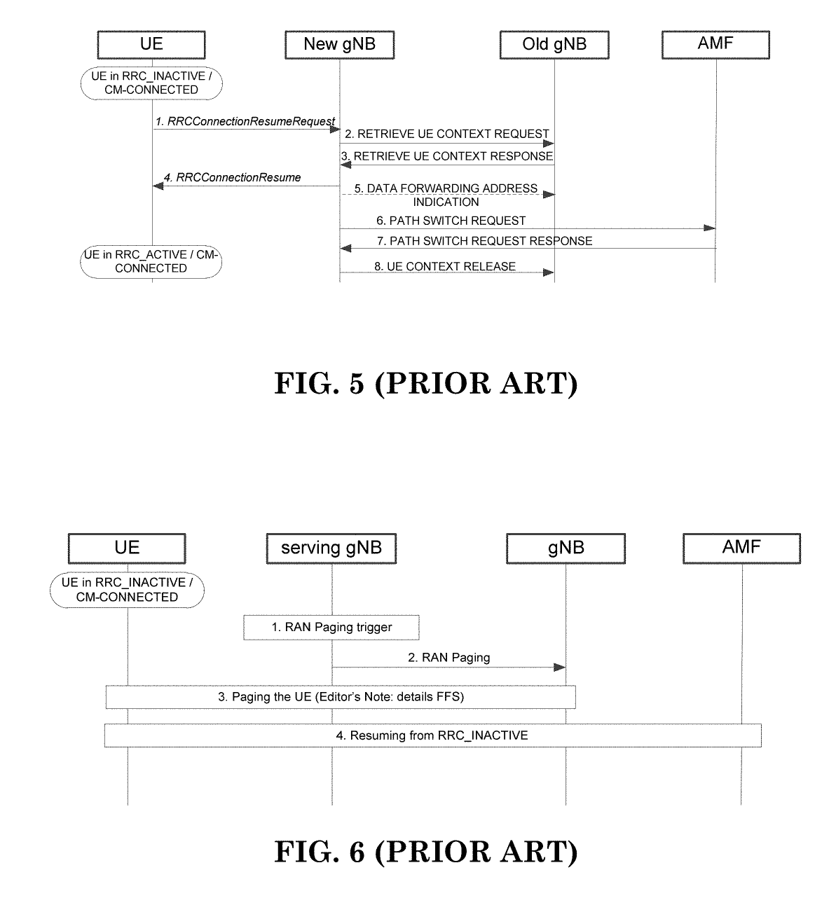

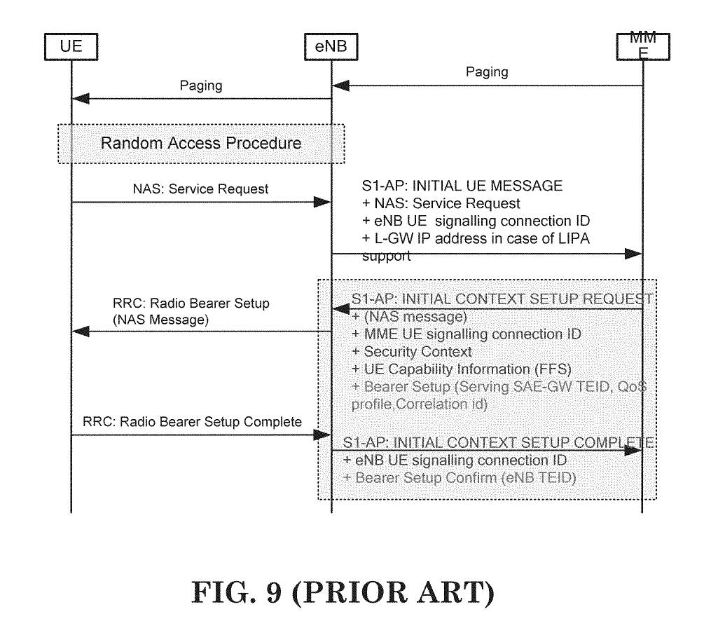

FIG. 5 (reproduction of FIG. 9.2.2.4.1-1 taken from 3GPP TS 38.300 v0.4.1).
1. The UE resumes from RRC_INACTIVE, providing the Resume ID, allocated by the old gNB.

Applicability of the term Resume ID for NG-RAN is pending RAN2.
2. The new gNB, if able to resolve the gNB identity contained in the Resume ID, requests the old gNB to provide UE Context data.

Applicability of the term Resume ID for NG-RAN is pending RAN2.
3. The old gNB provides UE context data.
4. The new gNB completes the resumption of the RRC connection.
5. If loss of DL user data buffered in the old serving gNB shall be prevented, the new gNB provides forwarding addresses.
6./7. The new gNB performs path switch.
8. The new gNB triggers the release of the UE resources at the old gNB.

More details to be added.
9.2.2.4.2 Network triggered transition from RRC_INACTIVE to RRC_CONNECTED

Some general text to be provided, mainly from RAN3

FIG. 6 (reproduction of FIG. 9.2.2.4.2-1 taken from 3GPP TS 38.300 v0.4.1).
1. A RAN paging trigger event occurs (incoming DL user plane, DL signalling from 5GC, etc.)
2. RAN paging is triggered; either only in the cells controlled by the serving gNB or also by means of Xn RAN Paging, in other gNBs, being member of the RAN Paging area the UE is registered with.
3. The UE is paged with an NG-RAN allocated UE identity.

Details are FFS.
4. If the UE has been successfully reached, it attempts to resume from RRC_INACTIVE, as described in other sections.

More details to be added.

### 9.2.3 Mobility in RRC_CONNECTED

### 9.2.3.1 Overview

Network controlled mobility applies to UEs in RRC_CONNECTED and is categorized into two types of mobility: cell level mobility and beam level mobility.

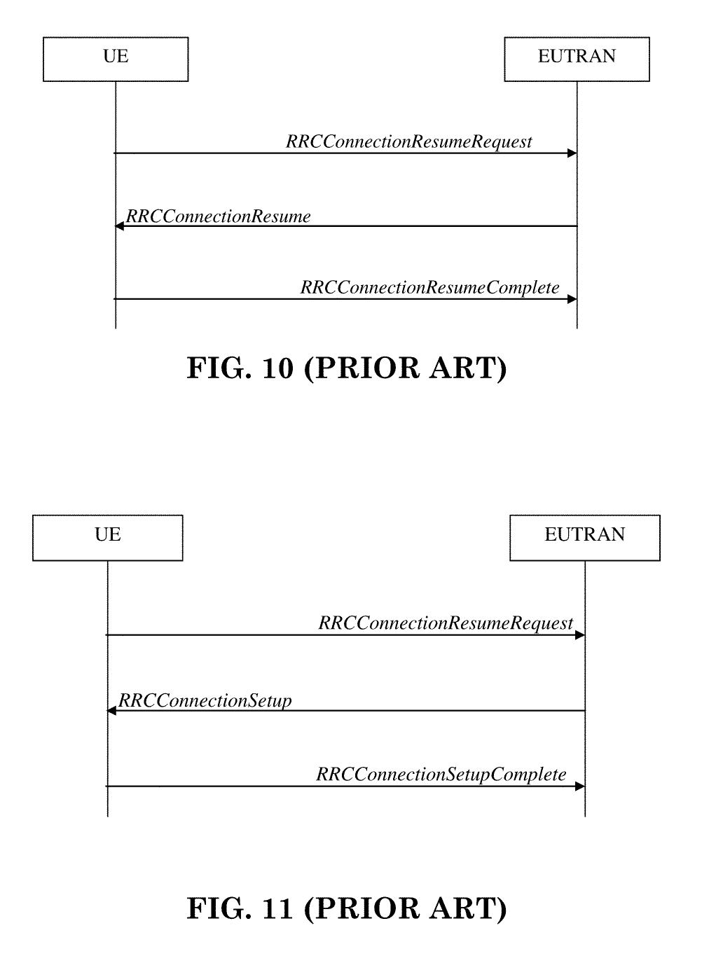

Cell Level Mobility requires explicit RRC signalling to be triggered, i.e. handover. For inter-gNB handover, the signalling procedures consist of at least the following elemental components illustrated in FIG. 10.2.3-1:

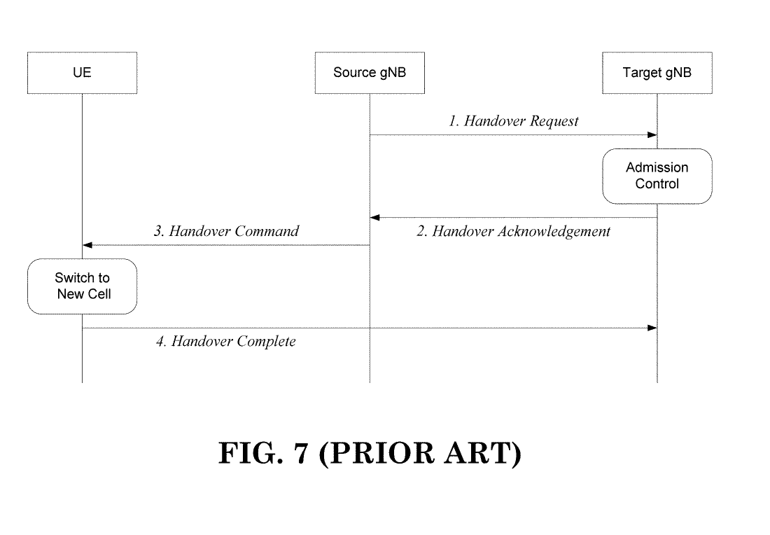

FIG. 7 (reproduction of FIG. 9.2.3-1 taken from 3GPP TS 38.300 v0.4.1).
1. The source gNB initiates handover and issues a Handover Request over the Xn interface.
2. The target gNB performs admission control and provides the RRC configuration as part of the Handover Acknowledgement.
3. The source gNB provides the RRC configuration to the UE in the Handover Command. The Handover Command message includes at least cell ID and all information required to access the target cell so that the UE can access the target cell without reading system information. For some cases, the information required for contention based and contention free random access can be included in the Handover Command message. The access information to the target cell may include beam specific information, if any.
4. The UE moves the RRC connection to the target gNB and replies the Handover Complete.

Exact message name FFS. Further enhancements and modifications can be considered.

The handover mechanism triggered by RRC requires the UE at least to reset the MAC entity and re-establish RLC. For DRBs using RLC AM mode, PDCP can either be re-established together with a security key change or initiate a data recovery procedure without a key change. For DRBs using RLC UM mode and for SRBs, PDCP can either be re-established together with a security key change or remain as it is without a key change.

Data forwarding, in-sequence delivery and duplication avoidance at handover can be guaranteed when the target gNB uses the same DRB configuration and QoS flow to DRB mapping as the source gNB.

FFS whether QoS flow can be remapped at handover and, if supported, whether the handover is lossless in this case.

Beam Level Mobility does not require explicit RRC signalling to be triggered—it is dealt with at lower layers—and RRC is not required to know which beam is being used at a given point in time.

FFS whether there may be cases for which intra-cell mobility needs to be handled by RRC.

### 9.2.3.2 Handover

### 9.2.3.2.1 C-Plane Handling

The intra-NR RAN handover performs the preparation and execution phase of the handover procedure performed without involvement of the 5GC, i.e. preparation messages are directly exchanged between the gNBs. The release of the resources at the source gNB during the handover completion phase is triggered by the target gNB. The figure below depicts the basic handover scenario where neither the AMF nor the UPF changes:

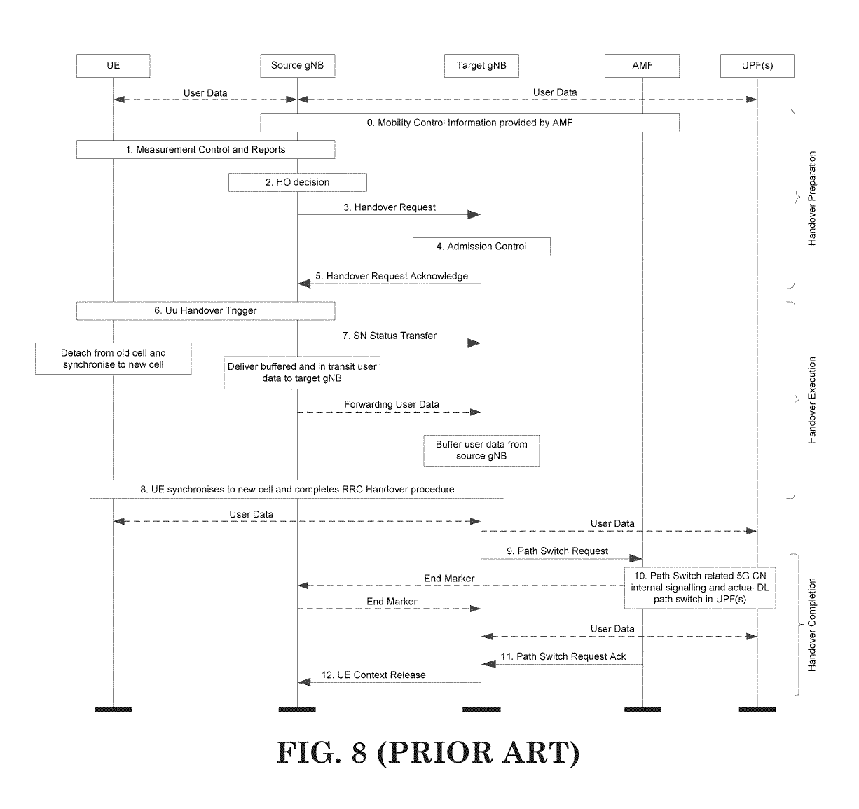

FIG. 8 (reproduction of FIG. 9.2.3.2.1-1 taken from 3GPP TS 38.300 v0.4.1).
0. The UE context within the source gNB contains information regarding roaming and access restrictions which were provided either at connection establishment or at the last TA update.
1. The source gNB configures the UE measurement procedures and the UE reports according to the measurement configuration.
2. The source gNB decides to handover the UE, based on MEASUREMENT REPORT and RRM information.
3. The source gNB issues a HANDOVER REQUEST message to the target gNB passing necessary information to prepare the HO at the target side
4. Admission Control may be performed by the target gNB.
5. The target gNB prepares HO with L1/L2 and sends the HANDOVER REQUEST ACKNOWLEDGE to the source gNB.
6. The target gNB generates the RRC message to perform the handover.
7. The source gNB sends the SN STATUS TRANSFER message to the target gNB.
8. The UE synchronises to the target cell and completes the RRC handover procedure.
9. The target gNB sends a PATH SWITCH REQUEST message to AMF to trigger 5GC to switch the DL data path towards the target gNB and to establish an NG-C interface instance towards the target gNB.
10. 5GC switches the DL data path towards the target gNB
11. The AMF confirms the PATH SWITCH REQUEST message with the PATH SWITCH REQUEST ACKNOWLEDGE message.
12. By sending the UE CONTEXT RELEASE message, the target gNB informs the source gNB about the success of HO and triggers the release of resources by the source gNB. The target gNB sends this message after the PATH SWITCH REQUEST ACKNOWLEDGE message is received from the AMF. Upon reception of the UE CONTEXT RELEASE message, the source gNB can release radio and C-plane related resources associated to the UE context. Any ongoing data forwarding may continue.

More details to be added by RAN2 and RAN3 in coordination with SA2.

### 9.2.3.2.2 U-Plane Handling

3GPP TS36.300 introduces that the network initiates UE context setup procedure when RRC_IDLE transits to RRC_CONNECTED as follows:

### 19.2.2.3 Initial Context Setup Procedure

The Initial Context Setup procedure establishes the necessary overall initial UE context in the eNB in case of an Idle-to Active transition. The Initial Context Setup procedure is initiated by the MME.

The Initial Context Setup procedure comprises the following steps:
The MME initiates the Initial Context Setup procedure by sending INITIAL CONTEXT SETUP REQUEST to the eNB. This message may include general UE Context (e.g. security context, roaming and access restrictions, UE capability information, UE 51 signalling connection ID, CN assistance information, etc.), E-RAB context (Serving GW TEID, QoS information, Correlation id i.e. collocated L-GW TEID or GRE key in case of LIPA support or in case of SIPTO@LN with collocated L-GW support), and may be piggy-backed with the corresponding NAS messages. When there are multiple NAS messages in the INITIAL CONTEXT SETUP REQUEST message, the MME shall ensure that the NAS messages in the E-RAB to be Setup List are aligned in the order of reception from the NAS layer to ensure the in-sequence delivery of the NAS messages.
Upon receipt of INITIAL CONTEXT SETUP REQUEST, the eNB setup the context of the associated UE, and perform the necessary RRC signalling towards the UE, e.g. Radio Bearer Setup procedure. When there are multiple NAS messages to be sent in the RRC message, the order of the NAS messages in the RRC message shall be kept the same as that in the INITIAL CONTEXT SETUP REQUEST message. If present, the eNB uses the CN assistance information as defined in TS 23.401[17] and propagates it during inter-eNB mobility.
The eNB responds with INITIAL CONTEXT SETUP RESPONSE to inform a successful operation, and with INITIAL CONTEXT SETUP FAILURE to inform an unsuccessful operation.
NOTE: In case of failure, eNB and MME behaviours are not mandated. Both implicit release (local release at each node) and explicit release (MME-initiated UE Context Release procedure) may in principle be adopted. The eNB should ensure that no hanging resources remain at the eNB.

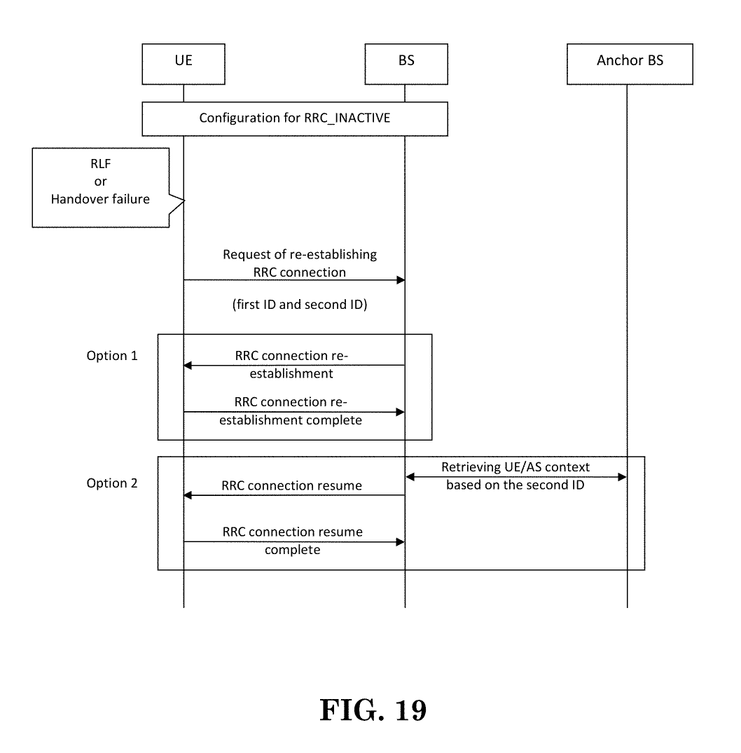

FIG. 9 (reproduction of FIG. 19.2.2.3-1 taken from 3GPP TS36.300 v14.2.0).

3GPP R2-1706723 introduces implicit state transition from CONNECTED to INACTIVE state with pre-configured INACTIVE state parameters as quoted below:

2.1 RRC Procedure from CONNECTED State to INACTIVE State

The following parameters should be provided to the UE when instructing the UE to move to INACTIVE state:

1. RAN Notification Area configuration

2. UE Context ID (to identify the UE context in the connection re-activation procedure)

3. DRX parameter (RAN configured DRX for INACTIVE state UE)

4. Periodic RAN notification area update timer

In addition to the parameters which are specific to the INACTIVE state, the network may include some parameters which are common to INACTIVE and IDLE state:

5. Redirection info (to redirect the UE to an inter-frequency)

6. Mobility control info (dedicated cell reselection priorities)

Proposal 1: The RAN Notification Area, the UE context identifier, DRX parameter, redirection info, and mobility control info can be provided to the UE when configuring the UE to enter INACTIVE state.

Based on the contents discussed above, it can be seen that the message used for CONNECTED mode to INACTIVE mode transmission shares some common information with the RRC Connection Release message, and it also include some information which is specific to INACTIVE state. Since we have already agreed that “the RRC state transition from CONNECTED to INACTIVE follows one step procedure” , we suggest to use the same RRC Connection Release kind of message for CONNECTED to INACTIVE and CONNECTED to IDLE state transition.

Proposal 2: Use the same RRC Connection Release kind of message for CONNECTED to INACTIVE and CONNECTED to IDLE state transition.

Usually, the network will configure the UE to enter INACTIVE state after the UE has no data transmission for a period of time. Instead of instructing the UE to enter INACTIVE state with an RRC message after some data transmission inactivity, the network could pre-configure the parameters to be used in INACTIVE state, and based on some criteria directly evaluated by the UE (for example inactivity timer), the UE could enter INACTVE state and apply the pre-configured parameters. This would avoid that the UE which has been in power saving operation has to receive and RRC message and transmit HARQ and ARQ ACK just for the purpose of moving to the INACTIVE state.

Proposal 3: Support implicit state transition from CONNECTED to INACTIVE state with pre-configured INACTIVE state parameters.

3GPP TS36.331 v14.2.1 introduces RRC connection control as quoted below:

5.3.3 RRC connection establishment

### 5.3.3.1 General

FIG. 10 (reproduction of FIG. 5.3.3.1-3 taken from 3GPP TS36.331 v14.2.1).

FIG. 11 (reproduction of FIG. 5.3.3.1-4 taken from 3GPP TS36.331 v14.2.1).

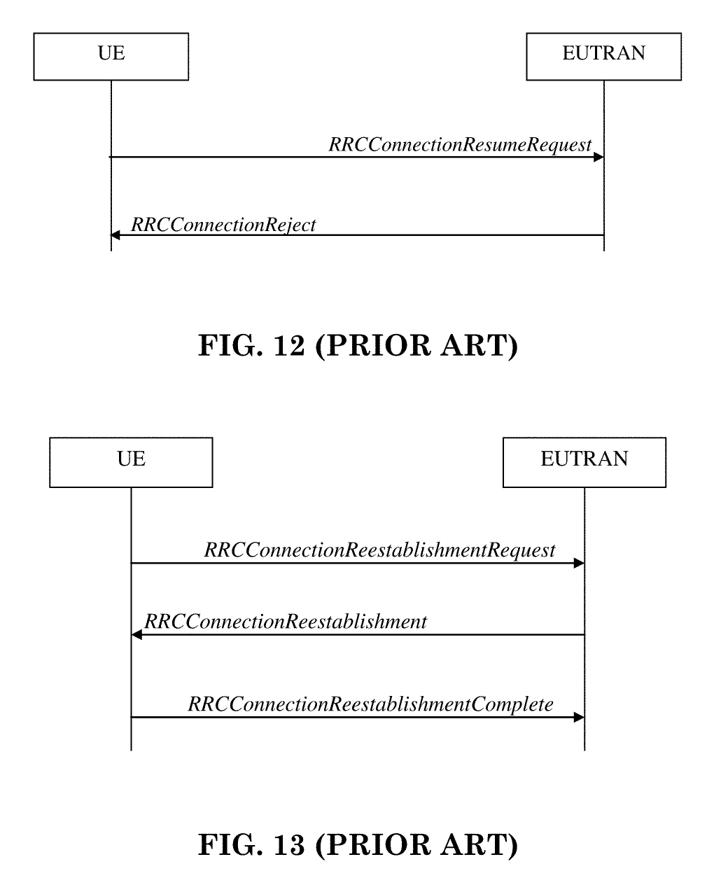

FIG. 12 (reproduction of FIG. 5.3.3.1-5 taken from 3GPP TS36.331 v14.2.1).

The purpose of this procedure is to establish or resume an RRC connection. RRC connection establishment involves SRB1 (and SRB ibis for NB-IoT) establishment. The procedure is also used to transfer the initial NAS dedicated information/ message from the UE to E-UTRAN.

E-UTRAN applies the procedure as follows:
When establishing an RRC connection:
   to establish SRB1 and, for NB-IoT, SRB ibis;
When resuming an RRC connection:
   to restore the AS configuration from a stored context including resuming SRB(s) and DRB(s).
      5.3.3.3a Actions related to transmission of RRCConnectionResumeRequest message

The UE shall set the contents of RRCConnectionResumeRequest message as follows:
1>if the UE is a NB-IoT UE; or
1>if field useFullResumeID is signalled in SystemInformationBlockType2:
   2>set the resumelD to the stored resumeldentity;
1>else
   2>set the truncatedResumelD to include bits in bit position 9 to 20 and 29 to 40 from the left in the stored resumeldentity.
1. if the UE supports mo-VoiceCall establishment cause and UE is resuming the RRC connection for mobile originating MMTEL voice and SystemInformationBlockType2 includes voiceServiceCauseIndication:
   2>set the resumeCause to mo-VoiceCall;
1>else if the UE supports mo-VoiceCall establishment cause for mobile originating MMTEL video and UE is resuming the RRC connection for mobile originating MMTEL video and SystemInformationBlockType2 includes videoServiceCauseIndication:
   2>set the resumeCause to mo-VoiceCall;
1>else
   2>set the resumeCause in accordance with the information received from upper layers;
1>set the shortResumeMAC-I to the 16 least significant bits of the MAC-I calculated:
   2>over the ASN.1 encoded as per section 8 (i.e., a multiple of 8 bits) VarShortResumeMAC-Input (or VarShortResumeMAC-Input-NB in NB-IoT);
   2>with the K_{RRCint} key and the previously configured integrity protection algorithm; and
   2>with all input bits for COUNT, BEARER and DIRECTION set to binary ones;
1>restore the RRC configuration and security context from the stored UE AS context:
1>restore the PDCP state and re-establish PDCP entities for SRB1;
1>resume SRB1;
NOTE: Until successful connection resumption, SRB1 is used only for the transfer RRCConnectionResume message.

The UE shall submit the RRCConnectionResumeRequest message to lower layers for transmission.

The UE shall continue cell re-selection related measurements as well as cell re-selection evaluation. If the conditions for cell re-selection are fulfilled, the UE shall perform cell re-selection as specified in 5.3.3.5.

### 5.3.3.4a Reception of the RRCConnectionResume by the UE

The UE shall:
1>stop timer T300;
1>restore the PDCP state and re-establish PDCP entities for SRB2 and all DRBs;
1>if drb-ContinueROHC is included:
   2>indicate to lower layers that stored UE AS context is used and that drb-ContinueROHC is configured;
   2>continue the header compression protocol context for the DRBs configured with the header compression protocol;
1>else:
   2>indicate to lower layers that stored UE AS context is used;
   2>reset the header compression protocol context for the DRBs configured with the header compression protocol;
1>discard the stored UE AS context and resumeldentity;
1>perform the radio resource configuration procedure in accordance with the received radioResourceConfigDedicated and as specified in 5.3.10;
1>resume SRB2 and all DRBs;
1>if stored, discard the cell reselection priority information provided by the idleModeMobilityControlInfo or inherited from another RAT;
1>for NB-IoT, if stored, discard the dedicated frequency offset provided by the redirectedCarrierOffsetDedicated;
1>if the RRCConnectionResume message includes the measConfig:
   2>perform the measurement configuration procedure as specified in 5.5.2;
1>stop timer T302, if running;
1>stop timer T303, if running;
1>stop timer T305, if running;
1>stop timer T306, if running;
1>stop timer T308, if running;
1>perform the actions as specified in 5.3.3.7;
1>stop timer T320, if running;
1>stop timer T350, if running;
1>perform the actions as specified in 5.6.12.4;
1>stop timer T360, if running;
1>stop timer T322, if running;
1>update the K_{eNB} key based on the K_{ASME} key to which the current K_{eNB} is associated, using the nextHopChainingCount value indicated in the RRCConnectionResume message, as specified in TS 33.401 [32];
1>store the nextHopChainingCount value;
1>derive the K_{RRCint} key associated with the previously configured integrity algorithm, as specified in TS 33.401 [32];
1>request lower layers to verify the integrity protection of the RRCConnectionResume message, using the previously configured algorithm and the K_{RRCint} key;
1>if the integrity protection check of the RRCConnectionResume message fails:
   2>perform the actions upon leaving RRC_CONNECTED as specified in 5.3.12, with release cause ‘other’, upon which the procedure ends;
1>derive the K_{RRCenc} key and the K_{UPenc} key associated with the previously configured ciphering algorithm, as specified in TS 33.401 [32];
1>configure lower layers to resume integrity protection using the previously configured algorithm and the K_{RRCint} key immediately, i.e., integrity protection shall be applied to all subsequent messages received and sent by the UE;
1>configure lower layers to resume ciphering and to apply the ciphering algorithm, the K_{RRCenc} key and the K_{UPenc} key, i.e. the ciphering configuration shall be applied to all subsequent messages received and sent by the UE;
1>enter RRC_CONNECTED;
1>indicate to upper layers that the suspended RRC connection has been resumed;
1>stop the cell re-selection procedure;
1>consider the current cell to be the PCell;
1>set the content of RRCConnectionResumeComplete message as follows:
   2>set the selectedPLMN-Identity to the PLMN selected by upper layers (see TS 23.122 [11], TS 24.301 [35]) from the PLMN(s) included in the plmn-IdentityList in SystemInformationBlockType1;
   2>set the dedicatedInfoNAS to include the information received from upper layers;
   2>except for NB-IoT:
      3>if the UE has radio link failure or handover failure information available in VarRLF-Report and if the RPLMN is included in plmn-IdentityList stored in VarRLF-Report:
         4>include rlf-InfoAvadable;
      3>if the UE has MBSFN logged measurements available for E-UTRA and if the RPLMN is included in plmn-IdentityList stored in VarLogMeasReport:
         4>include logMeasAvailableMBSFN;
      3>else if the UE has logged measurements available for E-UTRA and if the RPLMN is included in plmn-IdentityList stored in VarLogMeasReport:
         4>include logMeasAvailable;
      3>if the UE has connection establishment failure information available in VarConnEstFailReport and if the RPLMN is equal to plmn-Identity stored in VarConnEstFailReport:
         4>include connEstFailInfoAvailable;
      3>include the mobilityState and set it to the mobility state (as specified in TS 36.304 [4]) of the UE just prior to entering RRC_CONNECTED state;
      3>if the UE supports storage of mobility history information and the UE has mobility history information available in VarMobilityHistoryReport:
         4>include mobilityHistoryAvail;
1>submit the RRCConnectionResumeComplete message to lower layers for transmission;
1>the procedure ends.

### 5.3.7 RRC Connection Re-Establishment

### 5.3.7.1 General

FIG. 13 (reproduction of FIG. 5.3.7.1-1 taken from 3GPP TS36.331 v14.2.1).

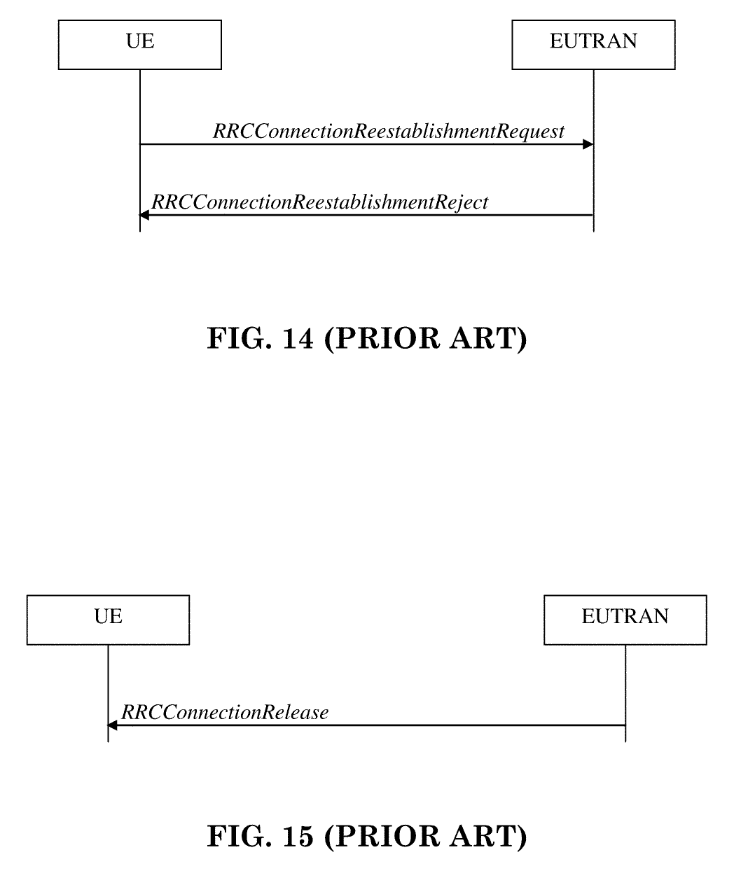

FIG. 14 (reproduction of FIG. 5.3.7.1-2 taken from 3GPP TS36.331 v14.2.1).

The purpose of this procedure is to re-establish the RRC connection, which involves the resumption of SRB1 operation, the re-activation of security and the configuration of only the PCell.

A UE in RRC_CONNECTED, for which security has been activated, may initiate the procedure in order to continue the RRC connection. The connection re-establishment succeeds only if the concerned cell is prepared i.e. has a valid UE context. In case E-UTRAN accepts the re-establishment, SRB1 operation resumes while the operation of other radio bearers remains suspended. If AS security has not been activated, the UE does not initiate the procedure but instead moves to RRC_IDLE directly.

E-UTRAN applies the procedure as follows:
to reconfigure SRB1 and to resume data transfer only for this RB;
to re-activate AS security without changing algorithms.

### 5.3.7.2 Initiation

The UE shall only initiate the procedure when AS security has been activated. The UE initiates the procedure when one of the following conditions is met:
1>upon detecting radio link failure, in accordance with 5.3.11; or
1>upon handover failure, in accordance with 5.3.5.6; or
1>upon mobility from E-UTRA failure, in accordance with 5.4.3.5; or
1>upon integrity check failure indication from lower layers; or
1>upon an RRC connection reconfiguration failure, in accordance with 5.3.5.5;

### 5.3.7.4 Actions Related to Transmission of RRCConnectionReestablishmentRequest Message

Except for NB-IoT, if the procedure was initiated due to radio link failure or handover failure, the UE shall:
1>set the reestablishmentCellId in the VarRLF-Report to the global cell identity of the selected cell;

The UE shall set the contents of RRCConnectionReestablishmentRequest message as follows:
1>set the ue-Identity as follows:
   2>set the c-RNTI to the C-RNTI used in the source PCell (handover and mobility from E-UTRA failure) or used in the PCell in which the trigger for the re-establishment occurred (other cases);
   2>set the physCellId to the physical cell identity of the source PCell (handover and mobility from E-UTRA failure) or of the PCell in which the trigger for the re-establishment occurred (other cases);
   2>set the shortMAC-I to the 16 least significant bits of the MAC-I calculated:
      3>over the ASN.1 encoded as per section 8 (i.e., a multiple of 8 bits) VarShortMAC-Input (or VarShortMAC-Input-NB in NB-IoT);
      3>with the K_{RRCint} key and integrity protection algorithm that was used in the source PCell (handover and mobility from E-UTRA failure) or of the PCell in which the trigger for the re-establishment occurred (other cases); and
      3>with all input bits for COUNT, BEARER and DIRECTION set to binary ones;
1>set the reestablishmentCause as follows:
   2>if the re-establishment procedure was initiated due to reconfiguration failure as specified in 5.3.5.5 (the UE is unable to comply with the reconfiguration):
      3>set the reestablishmentCause to the value reconfigurationFailure;
   2>else if the re-establishment procedure was initiated due to handover failure as specified in 5.3.5.6 (intra-LTE handover failure) or 5.4.3.5 (inter-RAT mobility from EUTRA failure):
      3>set the reestablishmentCause to the value handoverFailure;
   2>else:
      3>set the reestablishmentCause to the value otherFailure;

The UE shall submit the RRCConnectionReestablishmentRequest message to lower layers for transmission.

### 5.3.7.5 Reception of the RRCConnectionReestablishment by the UE

NOTE 1: Prior to this, lower layer signalling is used to allocate a C-RNTI. For further details see TS 36.321 [6];

The UE shall:
1>stop timer T301;
1>consider the current cell to be the PCell;
1>re-establish PDCP for SRB1;
1>re-establish RLC for SRB1;
1>perform the radio resource configuration procedure in accordance with the received radioResourceConfigDedicated and as specified in 5.3.10;
1>resume SRB1;
NOTE 2: E-UTRAN should not transmit any message on SRB1 prior to receiving the RRCConnectionReestablishmentComplete message.
1>update the K_{eNB} key based on the K_{ASME} key to which the current K_{eNB} is associated, using the nextHopChainingCount value indicated in the RRCConnectionReestablishment message, as specified in TS 33.401 [32];
1>store the nextHopChainingCount value;
1>derive the K_{RRCint} key associated with the previously configured integrity algorithm, as specified in TS 33.401 [32];
1>derive the K_{RRCint} key and the K_{UPenac} key associated with the previously configured ciphering algorithm, as specified in TS 33.401 [32];
1>if connected as an RN:
   2>derive the K_{UPint} key associated with the previously configured integrity algorithm, as specified in TS 33.401 [32];
1>configure lower layers to activate integrity protection using the previously configured algorithm and the K_{RRCint} key immediately, i.e., integrity protection shall be applied to all subsequent messages received and sent by the UE, including the message used to indicate the successful completion of the procedure;
1>if connected as an RN:
   2>configure lower layers to apply integrity protection using the previously configured algorithm and the K_{UPint} key, for subsequently resumed or subsequently established DRBs that are configured to apply integrity protection, if any;
1>configure lower layers to apply ciphering using the previously configured algorithm, the K_{RRCenc} key and the K_{UPenc} key immediately, i.e., ciphering shall be applied to all subsequent messages received and sent by the UE, including the message used to indicate the successful completion of the procedure;
1>if the UE is not a NB-IoT UE:
   2>set the content of RRCConnectionReestablishmentComplete message as follows:
      3>if the UE has radio link failure or handover failure information available in VarRLF-Report and if the RPLMN is included in phren-IdentityList stored in VarRLF-Report:
         4>include the rlf-InfoAvailable;
      3>if the UE has MBSFN logged measurements available for E-UTRA and if the RPLMN is included in phren-IdentityList stored in VarLogMeasReport and if T330 is not running:
         4>include logMeasAvailableMBSFN;
      3>else if the UE has logged measurements available for E-UTRA and if the RPLMN is included in phnn-IdentityList stored in VarLogMeasReport:
         4>include the logMeasAvailable;
      3>if the UE has connection establishment failure information available in VarConnEstFailReport and if the RPLMN is equal to plmn-Identity stored in VarConnEstFailReport:
         4>include the connEstFadInfoAvailable;
   2>perform the measurement related actions as specified in 5.5.6.1;
   2>perform the measurement identity autonomous removal as specified in 5.5.2.2a;
1>submit the RRCConnectionReestablishmentComplete message to lower layers for transmission;
1>if SystemInformationBlockType15 is broadcast by the PCell:
   2>if the UE has transmitted an MBMSInterestIndication message during the last 1 second preceding detection of radio link failure:
      3>ensure having a valid version of SystemInformationBlockType15 for the PCell;
      3>determine the set of MBMS frequencies of interest in accordance with 5.8.5.3;
      3>determine the set of MBMS services of interest in accordance with 5.8.5.3a;
      3>initiate transmission of the MBMSInterestIndication message in accordance with 5.8.5.4;
1>if SystemInformationBlockType18 is broadcast by the PCell; and the UE transmitted a SidelinkUEInformation message indicating a change of sidelink communication related parameters relevant in PCell (i.e. change of commRxInterestedFreq or commTxResourceReq, commTxResourceReqUC if SystemInformationBlockType18 includes commTxResourceUC-ReqAllowed or commTxResourceInfoReqRelay if PCell broadcasts SystemInformationBlockType19 including discConfigRelay) during the last 1 second preceding detection of radio link failure; or
1>if SystemInformationBlockType19 is broadcast by the PCell; and the UE transmitted a SidelinkUEInformation message indicating a change of sidelink discovery related parameters relevant in PCell (i.e. change of discRxInterest or discTxResourceReq, discTxResourceReqPS if SystemInformationBlockType19 includes discConfigPS or discRxGapReq or discTxGapReq if the UE is configured with gapRequestsAllowedDedicated set to true or if the UE is not configured with gapRequestsAllowedDedicated and SystemInformationBlockType19 includes gapRequestsAllowedCommon) during the last 1 second preceding detection of radio link failure; or
1>if SystemInformationBlockType21 including sl-V2X-ConfigCommon is broadcast by the PCell; and the UE transmitted a SidelinkUEInformation message indicating a change of V2X sidelink communication related parameters relevant in PCell (i.e. change of v2x-CommRxInterestedFreq or v2x-CommTxResourceReq) during the last 1 second preceding detection of radio link failure:
   2>initiate transmission of the SidelinkUEInformation message in accordance with 5.10.2.3;
1>the procedure ends;

### 5.3.8 RRC Connection Release

### 5.3.8.1 General

FIG. 15 (reproduction of FIG. 5.3.8.1-1 taken from 3GPP TS36.331 v14.2.1).

The purpose of this procedure is:
to release the RRC connection, which includes the release of the established radio bearers as well as all radio resources;
or:
to suspend the RRC connection, which includes the suspension of the established radio bearers.

### 5.3.8.2 Initiation

E-UTRAN initiates the RRC connection release procedure to a UE in RRC_CONNECTED.

### 5.3.8.3 Reception of the RRCConnectionRelease by the UE

The UE shall:
1>except for NB-IoT, BL UEs or UEs in CE, delay the following actions defined in this sub-clause 60 ms from the moment the RRCConnectionRelease message was received or optionally when lower layers indicate that the receipt of the RRCConnectionRelease message has been successfully acknowledged, whichever is earlier;
1>for BL UEs or UEs in CE, delay the following actions defined in this sub-clause 1.25 seconds from the moment the RRCConnectionRelease message was received or optionally when lower layers indicate that the receipt of the RRCConnectionRelease message has been successfully acknowledged, whichever is earlier;
1>for NB-IoT, delay the following actions defined in this sub-clause 10 seconds from the moment the RRCConnectionRelease message was received or optionally when lower layers indicate that the receipt of the RRCConnectionRelease message has been successfully acknowledged, whichever is earlier.
1>if the RRCConnectionRelease message includes the idleModeMobilityControlInfo:
   2>store the cell reselection priority information provided by the idleModeMobilityControlInfo;
   2>if the t320 is included:
      3>start timer T320, with the timer value set according to the value of t320;
1>else:
   2>apply the cell reselection priority information broadcast in the system information;
1>for NB-IoT, if the RRCConnectionRelease message includes the redirectedCarrierinfo:
   2>if the redirectedCarrierOffsetDedicated is included in the redirectedCarrierinfo:
      3>store the redirectedCarrierOffsetDedicated for the frequency in redirectedCarrierinfo;
      3>start timer T322, with the timer value set according to the value of T322 in redirectedCarrierinfo;
1>if the releaseCause received in the RRCConnectionRelease message indicates loadBalancingTAURequired:
   2>perform the actions upon leaving RRC_CONNECTED as specified in 5.3.12, with release cause ‘load balancing TAU required’;
1>else if the releaseCause received in the RRCConnectionRelease message indicates cs-FallbackHighPriority:
   2>perform the actions upon leaving RRC_CONNECTED as specified in 5.3.12, with release cause ‘CS Fallback High Priority’;
1>else:
   2>if the extendedWanTime is present; and
   2>if the UE supports delay tolerant access or the UE is a NB-IoT UE:
      3>forward the extendedWaitTime to upper layers;
   2>if the releaseCause received in the RRCConnectionRelease message indicates rrc-Suspend:
      3>perform the actions upon leaving RRC_CONNECTED as specified in 5.3.12, with release cause ‘RRC suspension’;
   2>else:
      3>perform the actions upon leaving RRC_CONNECTED as specified in 5.3.12, with release cause ‘other’;

### 5.3.11 Radio Link Failure Related Actions

### 5.3.11.1 Detection of Physical Layer Problems in RRC_CONNECTED

The UE shall:
1>upon receiving N310 consecutive “out-of-sync” indications for the PCell from lower layers while neither T300, T301, T304 nor T311 is running:
   2>start timer T310;
1>upon receiving N313 consecutive “out-of-sync” indications for the PSCell from lower layers while T307 is not running:
   2>start T313;
NOTE: Physical layer monitoring and related autonomous actions do not apply to SCells except for the PSCell.

### 5.3.11.2 Recovery of Physical Layer Problems

Upon receiving N311 consecutive “in-sync” indications for the PCell from lower layers while T310 is running, the UE shall:
1>stop timer T310;
1>stop timer T312, if running;
NOTE 1: In this case, the UE maintains the RRC connection without explicit signalling, i.e. the UE maintains the entire radio resource configuration.
NOTE 2: Periods in time where neither “in-sync” nor “out-of-sync” is reported by layer 1 do not affect the evaluation of the number of consecutive “in-sync” or “out-of-sync” indications.

Upon receiving N314 consecutive “in-sync” indications for the PSCell from lower layers while T313 is running, the UE shall:
1>stop timer T313;
   5.3.11.3 Detection of radio link failure

The UE shall:
1>upon T310 expiry; or
1>upon T312 expiry; or
1>upon random access problem indication from MCG MAC while neither T300, T301, T304 nor T311 is running; or
1>upon indication from MCG RLC that the maximum number of retransmissions has been reached for an SRB or for an MCG or split DRB:
   2>consider radio link failure to be detected for the MCG i.e. RLF;
   2>except for NB-IoT, store the following radio link failure information in the VarRLF-Report by setting its fields as follows:
      3>clear the information included in VarRLF-Report, if any;
      3>set the phren-IdentityList to include the list of EPLMNs stored by the UE (i.e. includes the RPLMN);
      3>set the measResultLastServCell to include the RSRP and RSRQ, if available, of the PCell based on measurements collected up to the moment the UE detected radio link failure;
      3>set the measResultNeighCells to include the best measured cells, other than the PCell, ordered such that the best cell is listed first, and based on measurements collected up to the moment the UE detected radio link failure, and set its fields as follows;
         4>if the UE was configured to perform measurements for one or more EUTRA frequencies, include the measResultListEUTRA;
         4>if the UE was configured to perform measurement reporting for one or more neighbouring UTRA frequencies, include the measResultListUTRA;
         4>if the UE was configured to perform measurement reporting for one or more neighbouring GERAN frequencies, include the measResultListGERAN;
         4>if the UE was configured to perform measurement reporting for one or more neighbouring CDMA2000 frequencies, include the measResultsCDMA2000;
         4>for each neighbour cell included, include the optional fields that are available;
NOTE 1: The measured quantities are filtered by the L3 filter as configured in the mobility measurement configuration. The measurements are based on the time domain measurement resource restriction, if configured. Blacklisted cells are not required to be reported.
   3>if detailed location information is available, set the content of the locationInfo as follows:
      4>include the locationCoordinates;
      4>include the horizontal Velocity, if available;
   3>set the failedPCellId to the global cell identity, if available, and otherwise to the physical cell identity and carrier frequency of the PCell where radio link failure is detected;
   3>set the tac-FailedPCell to the tracking area code, if available, of the PCell where radio link failure is detected;
   3>if an RRCConnectionReconfiguration message including the mobilityControlInfo was received before the connection failure:
      4>if the last RRCConnectionReconfiguration message including the mobilityControlInfo concerned an intra E-UTRA handover:
      5>include the previousPCellId and set it to the global cell identity of the PCell where the last RRCConnectionReconfiguration message including mobilityControlInfo was received;
      5>set the timeConnFailure to the elapsed time since reception of the last RRCConnectionReconfiguration message including the mobilityControlInfo;
      4>if the last RRCConnectionReconfiguration message including the mobilityControlInfo concerned a handover to E-UTRA from UTRA and if the UE supports Radio Link Failure Report for Inter-RAT MRO:
      5>include the previousUTRA-CellId and set it to the physical cell identity, the carrier frequency and the global cell identity, if available, of the UTRA Cell in which the last RRCConnectionReconfiguration message including mobilityControlInfo was received;
      5>set the timeConnFailure to the elapsed time since reception of the last RRCConnectionReconfiguration message including the mobilityControlInfo;
   3>if the UE supports QCI1 indication in Radio Link Failure Report and has a DRB for which QCI is 1:
      4>include the drb-EstablishedWithQCI-1;
   3>set the connectionFailureType to rlf;
   3>set the c-RNTI to the C-RNTI used in the PCell;
   3>set the rlf-Cause to the trigger for detecting radio link failure;
   2>if AS security has not been activated:
      3>if the UE is a NB-IoT UE:
         4>perform the actions upon leaving RRC_CONNECTED as specified in 5.3.12, with release cause ‘RRC connection failure’;
      3>else:
         4>perform the actions upon leaving RRC_CONNECTED as specified in 5.3.12, with release cause ‘other’;
   2>else:
      3>initiate the connection re-establishment procedure as specified in 5.3.7;

The UE shall:
1>upon T313 expiry; or
1>upon random access problem indication from SCG MAC; or
1>upon indication from SCG RLC that the maximum number of retransmissions has been reached for an SCG or split DRB:
   2>consider radio link failure to be detected for the SCG i.e. SCG-RLF;
   2>initiate the SCG failure information procedure as specified in 5.6.13 to report SCG radio link failure;

The UE may discard the radio link failure information, i.e. release the UE variable VarRLF-Report, 48 hours after the radio link failure is detected, upon power off or upon detach.

### 5.3.12 UE Actions Upon Leaving RRC_CONNECTED

Upon leaving RRC_CONNECTED, the UE shall:
1>reset MAC;
1>stop all timers that are running except T320, T322, T325, T330;
1>if leaving RRC_CONNECTED was triggered by suspension of the RRC:
   2>re-establish RLC entities for all SRBs and DRBs;
   2>store the UE AS Context including the current RRC configuration, the current security context, the PDCP state including ROHC state, C-RNTI used in the source PCell, the cellIdentity and the physical cell identity of the source PCell;
   2>store the following information provided by E-UTRAN:
      3>the resumeldentity;
   2>suspend all SRB(s) and DRB(s), except SRBO;
   2>indicate the suspension of the RRC connection to upper layers;
   2>configure lower layers to suspend integrity protection and ciphering;
NOTE: Ciphering is not applied for the subsequent RRCConnectionResume message used to resume the connection. An integrity check is performed by lower layers, but merely upon request from RRCs.
1>else:
   2>release all radio resources, including release of the RLC entity, the MAC configuration and the associated PDCP entity for all established RBs;
   2>indicate the release of the RRC connection to upper layers together with the release cause;
1>if leaving RRC_CONNECTED was triggered neither by reception of the MobilityFromEUTRACommand message nor by selecting an inter-RAT cell while T311 was running:
   2>if timer T350 is configured:
      3>start timer T350;
      3>apply rclwi-Configuration if configured, otherwise apply the wlan-Id-List corresponding to the RPLMN included in SystemInformationBlockType17;
   2>else:
      3>release the wlan-OffloadConfigDedicated, if received;
      3>if the wlan-OffloadConfigCommon corresponding to the RPLMN is broadcast by the cell:
         4>apply the wlan-OffloadConfigCommon corresponding to the RPLMN included in SystemInformationBlockType17;
         4>apply steerToWLAN if configured, otherwise apply the wlan-Id-List corresponding to the RPLMN included in SystemInformationBlockType17;
   2>enter RRC_IDLE and perform procedures as specified in TS 36.304 [4, 5.2.7];
1>else:
   2>release the wlan-OffloadConfigDedicated, if received;
NOTE: BL UEs or UEs in CE verifies validity of SI when released to RRC_IDLE.
1>release the LWA configuration, if configured, as described in 5.6.14.3;
1>release the LWIP configuration, if configured, as described in 5.6.17.3;

3GPP TS36.300 v14.2.0 introduces LTE handover procedure as quoted below:

### 10.1.2.1 Handover

The intra E-UTRAN HO of a UE in RRC_CONNECTED state is a UE-assisted network-controlled HO, with HO preparation signalling in E-UTRAN:
Part of the HO command comes from the target eNB and is transparently forwarded to the UE by the source eNB;
To prepare the HO, the source eNB passes all necessary information to the target eNB (e.g. E-RAB attributes and RRC context):
   When CA is configured and to enable SCell selection in the target eNB, the source eNB can provide in decreasing order of radio quality a list of the best cells and optionally measurement result of the cells.
   When DC is configured, the source MeNB provides the SCG configuration (in addition to the MCG configuration) to the target MeNB.
Both the source eNB and UE keep some context (e.g. C-RNTI) to enable the return of the UE in case of HO failure;
If RACH-less HO is not configured, the UE accesses the target cell via RACH following a contention-free procedure using a dedicated RACH preamble or following a contention-based procedure if dedicated RACH preambles are not available:
   the UE uses the dedicated preamble until the handover procedure is finished (successfully or unsuccessfully);
If RACH-less HO is configured, the UE accesses the target cell via the uplink grant preallocated to the UE in the RRC message. If the UE does not receive the preallocated uplink grant in the RRC message from the source eNB, the UE monitors the PDCCH of the target cell;
If the access towards the target cell (using RACH or RACH-less procedure) is not successful within a certain time, the UE initiates radio link failure recovery using a suitable cell;
No ROHC context is transferred at handover;
ROHC context can be kept at handover within the same eNB.

### 10.1.2.1.1 C-Plane Handling

The preparation and execution phase of the HO procedure is performed without EPC involvement, i.e. preparation messages are directly exchanged between the eNBs. The release of the resources at the source side during the HO completion phase is triggered by the eNB. In case an RN is involved, its DeNB relays the appropriate S1 messages between the RN and the MME (S1-based handover) and X2 messages between the RN and target eNB (X2-based handover); the DeNB is explicitly aware of a UE attached to the RN due to the S1 proxy and X2 proxy functionality (see section 4.7.6.6). The figure below depicts the basic handover scenario where neither MME nor Serving Gateway changes:

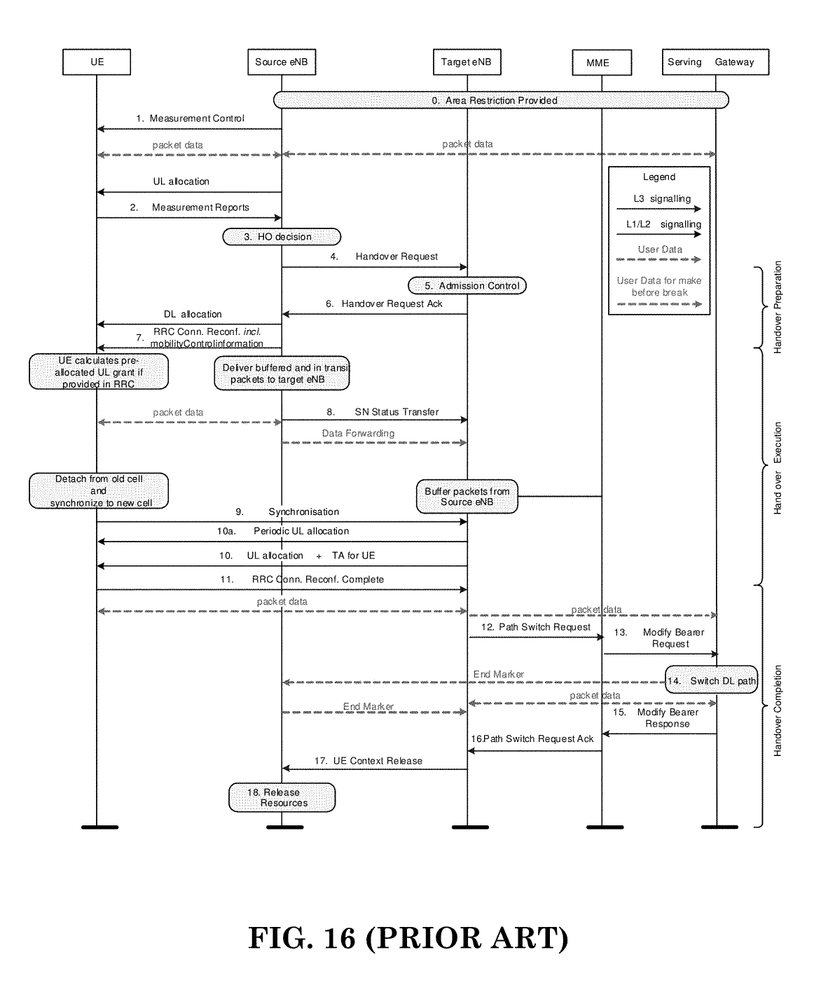

FIG. 16 (reproduction of FIG. 10.1.2.1.1-1 taken from 3GPP TS36.300 v14.2.0).

Below is a more detailed description of the intra-MME/Serving Gateway HO procedure:
0 The UE context within the source eNB contains information regarding roaming and access restrictions which were provided either at connection establishment or at the last TA update.
1 The source eNB configures the UE measurement procedures according to the roaming and access restriction information and e.g. the available multiple frequency band information. Measurements provided by the source eNB may assist the function controlling the UE's connection mobility.
2 A MEASUREMENT REPORT is triggered and sent to the eNB.
3 The source eNB makes decision based on MEASUREMENT REPORT and RRM information to hand off the UE.
4 The source eNB issues a HANDOVER REQUEST message to the target eNB passing necessary information to prepare the HO at the target side (UE X2 signalling context reference at source eNB, UE S1 EPC signalling context reference, target cell ID, K_{eNB}*, RRC context including the C-RNTI of the UE in the source eNB, AS-configuration, E-RAB context and physical layer ID of the source cell +short MAC-I for possible RLF recovery). UE X2 / UE S1 signalling references enable the target eNB to address the source eNB and the EPC. The E-RAB context includes necessary RNL and TNL addressing information, and QoS profiles of the E-RABs.
5 Admission Control may be performed by the target eNB dependent on the received E-RAB QoS information to increase the likelihood of a successful HO, if the resources can be granted by target eNB. The target eNB configures the required resources according to the received E-RAB QoS information and reserves a C-RNTI and optionally a RACH preamble. The AS-configuration to be used in the target cell can either be specified independently (i.e. an “establishment”) or as a delta compared to the AS-configuration used in the source cell (i.e. a “reconfiguration”).
6 The target eNB prepares HO with L1/L2 and sends the HANDOVER REQUEST ACKNOWLEDGE to the source eNB. The HANDOVER REQUEST ACKNOWLEDGE message includes a transparent container to be sent to the UE as an RRC message to perform the handover. The container includes a new C-RNTI, target eNB security algorithm identifiers for the selected security algorithms, may include a dedicated RACH preamble, and possibly some other parameters i.e. access parameters, SIBs, etc. If RACH-less HO is configured, the container includes timing adjustment indication and optionally a preallocated uplink grant. The HANDOVER REQUEST ACKNOWLEDGE message may also include RNL/TNL information for the forwarding tunnels, if necessary.
NOTE: As soon as the source eNB receives the HANDOVER REQUEST ACKNOWLEDGE, or as soon as the transmission of the handover command is initiated in the downlink, data forwarding may be initiated.

Steps 7 to 16 provide means to avoid data loss during HO and are further detailed in 10.1.2.1.2 and 10.1.2.3.
7 The target eNB generates the RRC message to perform the handover, i.e. RRCConnectionReconfiguration message including the mobilityControlInformation, to be sent by the source eNB towards the UE. The source eNB performs the necessary integrity protection and ciphering of the message.

The UE receives the RRCConnectionReconfiguration message with necessary parameters (i.e. new C-RNTI, target eNB security algorithm identifiers, and optionally dedicated RACH preamble, target eNB SIBs, etc.) and is commanded by the source eNB to perform the HO. If RACH-less HO is configured, the RRCConnectionReconfiguration includes timing adjustment indication and optionally preallocated uplink grant for accessing the target eNB. If preallocated uplink grant is not included, the UE should monitor PDCCH of the target eNB to receive an uplink grant. The UE does not need to delay the handover execution for delivering the HARQ/ARQ responses to source eNB.

If Make-Before-Break HO is configured, the connection to the source cell is maintained after the reception of RRCConnectionReconfiguration message with mobilityControlInformation before the UE executes initial uplink transmission to the target cell.
NOTE: If Make-Before-Break HO is configured, the source eNB decides when to stop transmitting to the UE.
NOTE: The UE can be configured with Make-Before-Break HO and RACH-less HO simultaneously.
8 The source eNB sends the SN STATUS TRANSFER message to the target eNB to convey the uplink PDCP SN receiver status and the downlink PDCP SN transmitter status of E-RABs for which PDCP status preservation applies (i.e. for RLC AM). The uplink PDCP SN receiver status includes at least the PDCP SN of the first missing UL SDU and may include a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.
9 If RACH-less HO is not configured, after receiving the RRCConnectionReconfiguration message including the mobilityControlInformation , UE performs synchronisation to target eNB and accesses the target cell via RACH, following a contention-free procedure if a dedicated RACH preamble was indicated in the mobilityControlInformation, or following a contention-based procedure if no dedicated preamble was indicated. UE derives target eNB specific keys and configures the selected security algorithms to be used in the target cell. If RACH-less HO is configured, UE performs synchronisation to target eNB. UE derives target eNB specific keys and configures the selected security algorithms to be used in the target cell.
10 If RACH-less HO is not configured, the target eNB responds with UL allocation and timing advance.
10a If RACH-less HO is configured and the UE did not get the periodic pre-allocated uplink grant in the RRCConnectionReconfiguration message including the mobilityControlInfo, the UE receives uplink grant via the PDCCH of the target cell. The UE uses the first available uplink grant after synchronization to the target cell.
11 When the UE has successfully accessed the target cell or received uplink grant when RACH-less HO is configured, the UE sends the RRCConnectionReconfigurationComplete message (C-RNTI) to confirm the handover, along with an uplink Buffer Status Report, whenever possible, to the target eNB to indicate that the handover procedure is completed for the UE. The target eNB verifies the C-RNTI sent in the RRCConnectionReconfigurationComplete message. The target eNB can now begin sending data to the UE.
12 The target eNB sends a PATH SWITCH REQUEST message to MME to inform that the UE has changed cell.
13 The MME sends a MODIFY BEARER REQUEST message to the Serving Gateway.
14 The Serving Gateway switches the downlink data path to the target side. The Serving gateway sends one or more “end marker” packets on the old path to the source eNB and then can release any U-plane/TNL resources towards the source eNB.
15 The Serving Gateway sends a MODIFY BEARER RESPONSE message to MME.
16 The MME confirms the PATH SWITCH REQUEST message with the PATH SWITCH REQUEST ACKNOWLEDGE message.
17 By sending the UE CONTEXT RELEASE message, the target eNB informs success of HO to source eNB and triggers the release of resources by the source eNB. The target eNB sends this message after the PATH SWITCH REQUEST ACKNOWLEDGE message is received from the MME.
18 Upon reception of the UE CONTEXT RELEASE message, the source eNB can release radio and C-plane related resources associated to the UE context. Any ongoing data forwarding may continue.

When an X2 handover is used involving HeNBs and when the source HeNB is connected to a HeNB GW, a UE CONTEXT RELEASE REQUEST message including an explicit GW Context Release Indication is sent by the source HeNB, in order to indicate that the HeNB GW may release of all the resources related to the UE context.

3GPP TS36.304 v14.3.0 introduces cell selection and reselection as quoted below:

### 5.2 Cell Selection and Reselection

### 5.2.1 Introduction

UE shall perform measurements for cell selection and reselection purposes as specified in [10].

The NAS can control the RAT(s) in which the cell selection should be performed, for instance by indicating RAT(s) associated with the selected PLMN, and by maintaining a list of forbidden registration area(s) and a list of equivalent PLMNs. The UE shall select a suitable cell based on idle mode measurements and cell selection criteria.

In order to speed up the cell selection process, stored information for several RATs may be available in the UE.

When camped on a cell, the UE shall regularly search for a better cell according to the cell reselection criteria. If a better cell is found, that cell is selected. The change of cell may imply a change of RAT. Details on performance requirements for cell reselection can be found in [10].

The NAS is informed if the cell selection and reselection results in changes in the received system information relevant for NAS.

For normal service, the UE shall camp on a suitable cell, tune to that cell's control channel(s) so that the UE can:
Receive system information from the PLMN; and
   receive registration area information from the PLMN, e.g., tracking area information; and
   receive other AS and NAS Information; and
if registered:
   receive paging and notification messages from the PLMN; and
   initiate transfer to connected mode.

### 5.2.3 Cell Selection Process

### 5.2.3.1 Description

The UE shall use one of the following two cell selection procedures:
a) Initial Cell Selection
   This procedure requires no prior knowledge of which RF channels are E-UTRA or NB-IoT carriers. The UE shall scan all RF channels in the E-UTRA bands according to its capabilities to find a suitable cell. On each carrier frequency, the UE need only search for the strongest cell. Once a suitable cell is found this cell shall be selected.
b) Stored Information Cell Selection
   This procedure requires stored information of carrier frequencies and optionally also information on cell parameters, from previously received measurement control information elements or from previously detected cells. Once the UE has found a suitable cell the UE shall select it. If no suitable cell is found the Initial Cell Selection procedure shall be started.
NOTE: Priorities between different frequencies or RATs provided to the UE by system information or dedicated signalling are not used in the cell selection process.

3GPP TS36.331 v14.2.1 specifies handover preparation information as quoted below:

### 10.2.2 Message Definition

### HandoverPreparationInformation

This message is used to transfer the E-UTRA RRC information used by the target eNB during handover preparation, including UE capability information.

Direction: source eNB/ source RAN to target eNB

### HandoverPreparationInformation Message

-- ASN1START
HandoverPreparationInformation ::= SEQUENCE {

| | |
|---|---|
| criticalExtensions | CHOICE { |

| | |
|---|---|
| c1 | CHOICE{ |

```
      handoverPreparationInformation-r8
  HandoverPreparationInformation-r8-IEs,
      spare7 NULL,
      spare6 NULL, spare5 NULL, spare4 NULL,
      spare3 NULL, spare2 NULL, spare1 NULL
    },
```

| | |
|---|---|
| criticalExtensionsFuture | SEQUENCE { } |
| } | |
| } | |

HandoverPreparationInformation-r8-IEs ::= SEQUENCE {

| | |
|---|---|
| ue-RadioAccessCapabilityInfo | UE-CapabilityRAT- |
| ContainerList, | |

| | | |
|---|---|---|
| as-Config | AS-Config | OPTIONAL, |
| -- Cond HO | | |
| rrm-Config | RRM-Config | OPTIONAL, |
| as-Context | AS-Context | OPTIONAL, -- |
| Cond HO | | |

| | |
|---|---|
| nonCriticalExtension | HandoverPreparationInformation- |

v920-IEs OPTIONAL
}
...
-- ASN1STOP

HandoverPreparationInformation field descriptions

as-Config
The radio resource configuration. Applicable in case of intra-E-UTRA
handover. If the target receives an incomplete MeasConfig and
RadioResourceConfigDedicated in the as-Config, the target eNB
may decide to apply the full configuration option
based on the ue-ConfigRelease.
as-Context
Local E-UTRAN context required by the target eNB.

### 10.3 Inter-Node RRC Information Element Definitions

### AS-Config

The AS-Config IE contains information about RRC configuration information in the source eNB which can be utilized by target eNB to determine the need to change the RRC configuration during the handover preparation phase. The information can also be used after the handover is successfully performed or during the RRC connection re-establishment or resume.

### AS-Config Information Element

-- ASN1START
AS-Config ::= SEQUENCE {

| | |
|---|---|
| sourceMeasConfig | MeasConfig, |

| | |
|---|---|
| sourceRadioResourceConfig | RadioResourceConfigDedicated, |
| sourceSecurityAlgorithmConfig | SecurityAlgorithmConfig, |

| | |
|---|---|
| sourceUE-Identity | C-RNTI, |

| | |
|---|---|
| sourceMasterInformationBlock | MasterInformationBlock, |

```
  sourceSystemInformationBlockType1
  SystemInformationBlockType1(WITH COMPONENTS
```

{..., nonCriticalExtension

```
ABSENT}),
  sourceSystemInformationBlockType2
  SystemInformationBlockType2,
```

| | |
|---|---|
| antennaInfoCommon | AntennaInfoCommon, |
| sourceDl-CarrierFreq | ARFCN-ValueEUTRA, |
| ..., | |

[[ sourceSystemInformationBlockType1Ext OCTET STRING
(CONTAINING

SystemInformationBlockType1-

| | |
|---|---|
| v890-IEs) OPTIONAL, | |
| sourceOtherConfig-r9 | OtherConfig-r9 |

```
  -- sourceOtherConfig-r9 should have been optional. A target
eNB compliant with this transfer
  -- syntax should support receiving an AS-Config not including
this extension addition group
  -- e.g. from a legacy source eNB
  ]],
```

| | |
|---|---|
| [[ sourceSCellConfigList-r10 | SCellToAddModList-r10 |
| OPTIONAL | |
| ]], | |
| [[ sourceConfigSCG-r12 | SCG-Config-r12 OPTIONAL |
| ]] | |
| } | |

| | |
|---|---|
| AS-Config-v9e0 ::= | SEQUENCE { |

| | |
|---|---|
| sourceDl-CarrierFreq-v9e0 | ARFCN-ValueEUTRA-v9e0 |
| } | |

| | |
|---|---|
| AS-Config-v10j0 ::= | SEQUENCE { |

| | |
|---|---|
| antennaInfoDedicatedPCell-v10i0 | AntennaInfoDedicated-v10i0 |
| OPTIONAL | |
| } | |

| | |
|---|---|
| AS-Config-v1250 ::= | SEQUENCE { |

| | |
|---|---|
| sourceWlan-OffloadConfig-r12 | WLAN-OffloadConfig-r12 |
| OPTIONAL, | |
| sourceSL-CommConfig-r12 | SL-CommConfig-r12 |
| OPTIONAL, | |
| sourceSL-DiscConfig-r12 | SL-DiscConfig-r12 |
| OPTIONAL | |
| } | |

| | |
|---|---|
| AS-Config-v1320 ::= | SEQUENCE { |

| | |
|---|---|
| sourceSCellConfigList-r13 | SCellToAddModListExt-r13 |
| OPTIONAL, | |
| sourceRCLWI-Configuration-r13 | RCLWI-Configuration-r13 |
| OPTIONAL | |
| } | |

| | |
|---|---|
| AS-Config-v14x0 ::= | SEQUENCE { |

| | |
|---|---|
| sourceSL-V2X-CommConfig-r14 | SL-V2X-ConfigDedicated-r14 |
| OPTIONAL, | |

| | |
|---|---|
| sourceLWA-Config-r14 | LWA-Config-r13 |
| OPTIONAL, | |

| | |
|---|---|
| sourceWLAN-MeasResult-r14 | MeasResultListWLAN-r13 |
| OPTIONAL | |
| } | |
| -- ASN1STOP | |

| | |
|---|---|
| NOTE: | The AS-Config re-uses information elements primarily created to cover the radio |
| | interface signalling requirements. Consequently, the information elements may |
| | include some parameters that are not relevant for the target eNB e.g. the SFN as |
| | included in the MasterInformationBlock. |
| ... | |

### AS-Context

The IE AS-Context is used to transfer local E-UTRAN context required by the target eNB.

### AS-Context Information Element

| | |
|---|---|
| -- ASN1START | |
| AS-Context ::= | SEQUENCE { |

| | |
|---|---|
| reestablishmentInfo | ReestablishmentInfo |
| OPTIONAL -- Cond HO | |
| } | |

| | |
|---|---|
| AS-Context-v1130 ::= | SEQUENCE { |

| | |
|---|---|
| idc-Indication-r11 | OCTET STRING (CONTAINING |

InDeviceCoexIndication-r11)

| | |
|---|---|
| OPTIONAL, -- Cond HO2 | |
| mbmsInterestIndication-r11 | OCTET STRING (CONTAINING |

MBMSInterestIndication-r11)

| | |
|---|---|
| OPTIONAL, -- Cond HO2 | |
| powerPrefIndication-r11 | OCTET STRING (CONTAINING |

UEAssistanceInformation-r11)

| | |
|---|---|
| OPTIONAL, -- Cond HO2 | |
| ..., | |
| [[ sidelinkUEInformation-r12 | OCTET STRING (CONTAINING |

| | SidelinkUEInformation-r12) |
|---|---|
| OPTIONAL -- Cond HO2 | |
| ]] | |
| } | |
| AS-Context-v1320 ::= | SEQUENCE { |

| | |
|---|---|
| wlanConnectionStatusReport-r13 | OCTET STRING (CONTAINING |

WLANConnectionStatusReport-r13)

OPTIONAL -- Cond HO2
}
-- ASN1STOP

3GPP RAN2#101bis Chairman's notes made following agreements as quoted below:
1. Re-establishment kind message is sent on SRB1 (with at least integrity protection) with the intention to allow re-establishment of DRBs without the network having to wait for the reception of re-establishment complete message.
2. Network can response to the Reestablishment Request kind message with an RRC connection setup in case of RRC re-establishment failure.

FFS Whether it is also possible for the network to response with RRC Reject.

In New RAT (NR), a new Radio Resource Control (RRC) state (i.e. RRC_INACTIVE) is introduced in 3GPP TS38.300 v0.4.1. According to 3GPP TS38.300 v0.4.1, in a RRC_INACTIVE, the last serving Next Generation Radio Access Network (NG-RAN) node (e.g. the anchor next generation Node B (gNB)) keeps the UE information (e.g., UE context, AS context and/or AS configuration) and the UE-associated NG connection (e.g., a 51 connection in LTE as disclosed 3GPP TS36.300 v14.2.0) with the serving AMF and UPF. 3GPP R2-1706723 proposes to configure a UE in RRC_CONNECTED with parameters to be used in RRC_INACTIVE beforehand. Based on 3GPP R2-1706723, the UE could enter RRC_INACTIVE based on some criteria directly evaluated by the UE. The criteria could be based on an inactive state timer, e.g. entering RRC_INACTIVE upon expiry of the inactive state timer. Both the UE and the gNB should have the same understanding about the current RRC state of the UE based on the inactive state timer. For example, the UE and the gNB would run the inactive state timer on each side so that the gNB understands the UE will enter RRC_INACTIVE upon expiry of the inactive state timer. Possibly, the parameters to be used in RRC_INACTIVE could derive a RAN notification area information. Possibly, the parameters to be used in RRC_INACTIVE could include an identity (e.g. resumeldentity as disclosed in 3GPP TS36.331 v14.2.1) used to resume RRC connection. Possibly, the parameters to be used in RRC_INACTIVE could include the configuration of the RAN notification area. Possibly, the length of the inactive state timer could be configured by a RRC (connection) reconfiguration message.

In a LTE, a UE performs a RRC connection re-establishment procedure in RRC_CONNECTED upon handover failure, radio link failure, or other similar failures. When the UE performs the RRC connection re-establishment procedure, the UE first performs a cell selection. In general, the network could prepare UE information of the UE for several prepared cell(s) including the serving cell(s) serving the UE. During the cell selection, if the UE selects a prepared cell, the RRC connection re-establishment procedure will be successful. Otherwise, if the UE selects a cell that is not a prepared cell, the RRC connection re-establishment procedure will be failed. If the RRC connection re-establishment procedure is failed, the UE enters RRC_IDLE (and releases the UE information). Afterwards, the upper layer of the UE may trigger the RRC layer of the UE to perform the RRC connection establishment procedure to establish a new RRC connection, and the network again establishes UE information of the UE, by way of example, via Initial Context Setup procedure 3GPP TS36.300 v14.2.0. The UE information of the UE could include, for example UE context of the UE, AS context of the UE, or AS configuration of the UE. The UE context of the UE could include, for example security context, roaming and access restrictions, UE capability information, UE 51 signalling connection ID, CN assistance information related to the UE. The AS context of the UE could include information used for re-establishing a RRC connection, for example, reestablishmentInfo as disclosed in 3GPP TS36.331 v14.2.1. The AS configuration of the UE could include information about the RRC configuration information in a source gNB which can be utilized by a target gNB to determine the need to change the RRC configuration during the handover preparation phase. The information included in the AS configuration of the UE can also be used after the handover is successfully performed, during the RRC connection re-establishment, or RRC connection resumption.

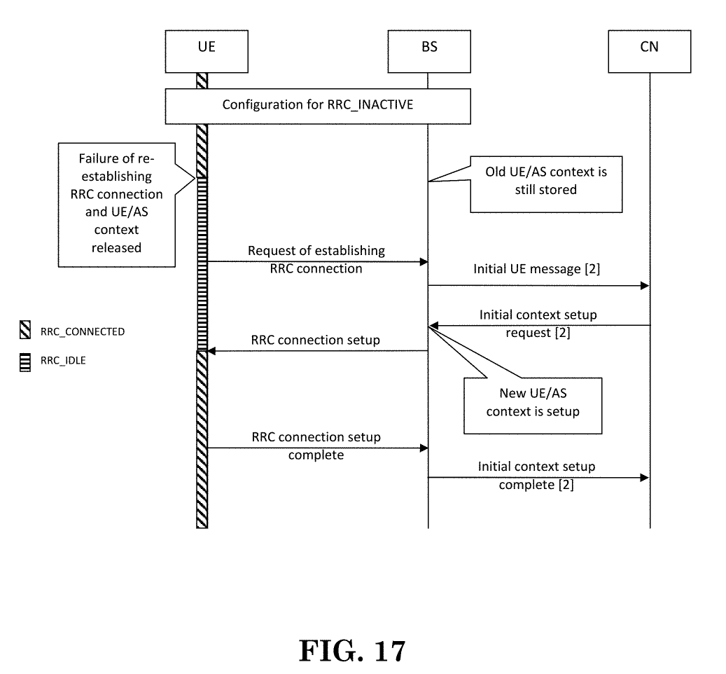

Assuming that the NR follows LTE principles, if the UE performs a procedure used to re-establish a RRC connection (e.g., a RRC connection re-establishment procedure) is not successful, a NR UE enters RRC_IDLE and releases the UE information even if the NR UE has configured/pre-configured parameters to be used in RRC_INACTIVE. In this situation, the NR UE has to trigger the establishment of a new RRC connection in order to setup a new UE information of the NR UE. The setup of the new UE information is not necessary because the original UE information of the NR UE is still stored in the network (or the network may not know that the NR UE has entered RRC_IDLE). And it would cause signaling overhead. This issue is illustrated in FIG. 17.

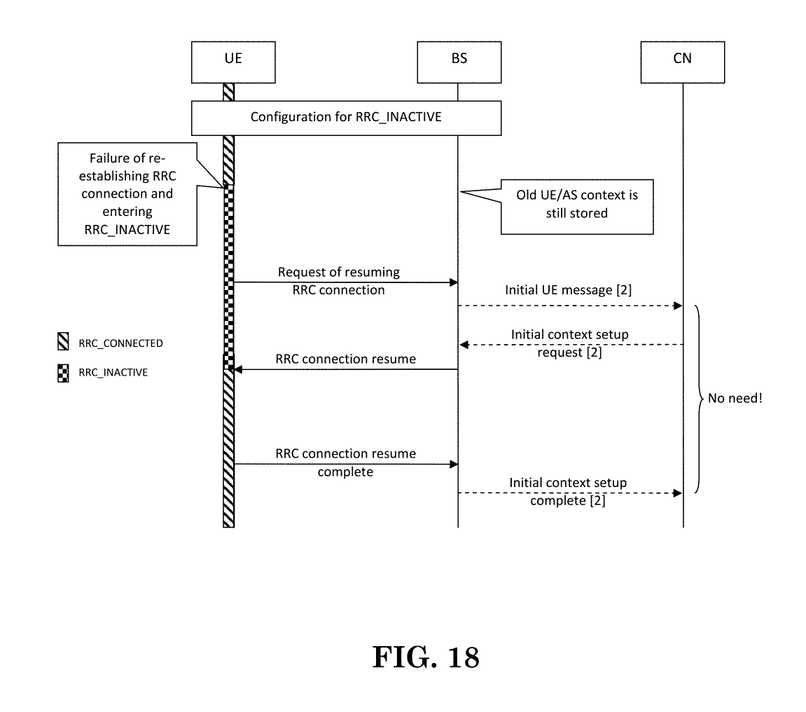

Several solutions to this issue are described below. In one alternative as illustrated in FIG. 18, the UE enters RRC_INACTIVE upon failure of a re-establishment of a RRC connection if the UE has parameters to be used in RRC_INACTIVE. The UE may perform a procedure used to re-establish a RRC connection between the UE and the network. When the procedure used to re-establish the RRC connection is not successful (e.g., due to reception of a release message (e.g., a RRC connection release) or the receipt of a reject message (e.g., RRC re-establishment reject or RRC connection re-establishment reject) from the network), the UE should enter RRC INACTIVE instead of RRC_IDLE. If a UE can enter RRC INACTIVE based on configured parameters to be used in RRC_INACTIVE (and/or the UE is in RAN notification area), the UE should enter RRC_INACTIVE instead of RRC_IDLE. Otherwise, for example, if the UE is not able to enter RRC_INACTIVE, the UE enters RRC_IDLE. The RAN notification area could be derived from the parameters to be used in RRC_INACTIVE or indicated by the network.

Possibly, the procedure used to re-establish the RRC connection between the UE and the network may be failed because the network responds to the UE with a reject message (i.e., the UE may receive the reject message in response to a request message of the procedure from the network). The request message of the procedure is sent to the network from the UE and is used to re-establish the RRC connection. In one embodiment, the request message of the procedure could be RRCConnectionReestablishmentRequest as disclosed in 3GPP TS36.331 v14.2.1. The reject message is sent to the UE from the network and is used to indicate the UE to enter RRC_INACTIVE (from RRC_CONCCECTED) or to stay in RRC_INACTIVE. The reject message could be RRCConnectionReestablishmentReject as disclosed in 3GPP TS36.331 v14.2.1. The reject message could also include the parameters to be used in RRC_INACTIVE. When the procedure used to re-establish RRC connection is not successful, if a UE is able to enter RRC_INACTIVE based on the parameters to be used in RRC_INACTIVE provided in the reject message (and/or the UE is in RAN notification area), the UE should enter RRC_INACTIVE instead of RRC_IDLE. Otherwise, for example, if the UE is not able to enter RRC_INACTIVE (because the reject message does not include the parameters to be used in RRC_INACTIVE or the UE is not configured with the parameters to be used in RRC_INACTIVE beforehand), the UE enters RRC_IDLE. The RAN notification area could be derived from the parameters to be used in RRC_INACTIVE or indicated by the network.

When the procedure used to re-establish a RRC connection is not successful, the UE may perform a cell selection or reselection to find a cell to camp on in RRC_INACTIVE or the UE may camp on the current cell where the UE leaves from RRC_CONNECTED to RRC_INACTIVE.

In one embodiment, the UE is able to enter RRC_INACTIVE based on the configured parameters to be used in RRC_INACTIVE because the UE could receive a first dedicated signaling including the configured parameters from the network in RRC_CONNECTED. The UE could receive a second dedicated signaling that indicates to the UE to enter RRC_INACTIVE from the network. Alternatively, the UE could enter RRC_INACTIVE based on a specific timer used to control timing to enter RRC_INACTIVE. The second dedicated signaling does not include the parameters to be used in RRC_INACTIVE but includes at least an indication indicating the UE to enter RRC_INACTIVE. The specific timer (which could run on the RRC layer or MAC layer) could be configured by the network. The first dedicated signaling could be a RRC connection reconfiguration message. The second dedicated signaling could be a RRC connection release message.

In another embodiment, the UE is not able to enter RRC_INACTIVE because the UE does not have the parameters to be used in RRC_INACTIVE. Alternatively, the UE is not able to enter RRC_INACTIVE because the UE has invalid parameters. In these situations, the UE can enter RRC_INACTIVE based on a third dedicated signaling to indicate the UE to enter RRC_INACTIVE. The third dedicated signaling may include parameters used in RRC_INACTIVE. The third dedicated signaling could be sent from the network to the UE. The third dedicated signaling could be a RRC connection release message.

In one embodiment, the release message or the reject message could be used to indicate the UE to enter RRC_INACTIVE or RRC_IDLE (from RRC_CONNECTED).

In one embodiment, the release message or the reject message could include the parameters to be used in RRC_INACTIVE.

Upon leaving RRC_CONNECTED, the UE or the RRC layer of the UE could indicate transition to RRC_INACTIVE or RRC_IDLE to the upper layer(s) of the UE.

In RRC_INACTIVE, if the upper layer(s) of the UE requires RRC connection, the UE or the RRC layer of the UE could initiate a procedure to resume a RRC connection for the transition from RRC_INACTIVE to RRC_CONNECTED; otherwise, the UE may retain the current RRC state.

In RRC_IDLE, if the upper layer(s) of the UE requires a RRC connection, the UE or the RRC layer of the UE could initiate a procedure to establish a RRC connection for the transition from RRC_IDLE to RRC_CONNECTED; otherwise, the UE may retain the current RRC state.

The UE may try to return to RRC_CONNECTED after entering RRC_INACTIVE because the UE may have user plane data and/or control plane data pending for transmission.

In one embodiment, the UE may initiate a procedure to resume a RRC connection upon/in response to the failure of re-establishing a RRC connection. The UE may not initiate the procedure to resume the RRC connection upon/in response to the reception of a dedicated signaling indicating to the UE to enter RRC_INACTIVE. The dedicated signaling could be a RRC connection release message. The UE may not initiate the procedure to resume the RRC connection upon/in response to the expiry of a specific timer controlling the timing to enter RRC_INACTIVE.

In one embodiment, the UE may initiate a procedure to resume a RRC connection upon/in response to the failure of re-establishing a RRC connection and there is user plane data pending for transmission. A data radio bearer (DRB) serving the user plane data may not be suspended.

In one embodiment, the UE may not initiate a procedure to resume a RRC connection upon/in response to the failure of re-establishing a RRC connection and there is user plane data pending for transmission, but a DRB serving the user plane data is suspended or all DRBs serving the user plane data are suspended.

In one embodiment, the UE may initiate a procedure to resume a RRC connection upon/in response to the failure of re-establishing a RRC connection and there is control plane data pending for transmission. A signaling radio bearer (SRB) serving the control plane data may not be suspended.

In one embodiment, the UE may not initiate a procedure to resume a RRC connection upon/in response to the failure of re-establishing RRC connection and there is control plane data pending for transmission, but a SRB serving the control plane data is suspended or all SRBs serving the control plane data are suspended.

In one embodiment, the UE may initiate a procedure to resume a RRC connection upon/in response to the failure of re-establishing a RRC connection and there is a lower layer signaling pending for transmission. The lower layer signaling could be a Packet Data Convergence Protocol (PDCP) control Packet Data Unit (PDU) (e.g., status report as described in 3GPP TS38.323 v0.0.5), a MAC control element (e.g. buffer status report, or power headroom report as described in 3GPP TS38.321 v0.0.3) or the like.

In one embodiment, the DRB and/or the SRB may not be suspended in RRC_INACTIVE if the UE enters RRC_INACTIVE upon/in response to failure of re-establishing a RRC connection. Alternatively, the DRB and/or the SRB may be suspended in RRC_INACTIVE if the UE enters RRC_INACTIVE upon/in response to other case not related to failure of re-establishing RRC connection. The other case could be the reception of an indication to enter RRC_INACTIVE or the expiry of a specific timer controlling the timing to enter RRC_INACTIVE.

FIG. 19 illustrates another alternative that is an enhancement on a procedure to re-establish a RRC connection. The UE could provide to the network with a first identity (e.g., ReestabUE-Identity as described in 3GPP TS36.331 v14.2.1) used to re-establish RRC connection and a second identity (e.g. resumeIdentity as described in TS36.331 v14.2.1) used to resume RRC connection when the UE performs a procedure used to re-establish RRC connection. When performing the procedure used to re-establish a RRC connection, the UE could be in RRC_CONNECTED.

In one embodiment, the UE could include the first identity and the second identity in a request message (e.g., RRCConnectionReestablishmentRequest as described in 3GPP TS36.331 v14.2.1) of the procedure used to re-establish a RRC connection if the UE has parameters to be used in RRC_INACTIVE.

In one embodiment, the UE could include the first identity and the second identity in a request message (e.g., RRCConnectionReestablishmentRequest as described in 3GPP TS36.331 v14.2.1) of the procedure used to re-establish a RRC connection if the UE is in a RAN notification area. The RAN notification area could be derived from configured and/or pre-configured parameters to be used in RRC_INACTIVE or as indicated by the network.

In one embodiment, the UE could include the first identity and the second identity in a request message (e.g., RRCConnectionReestablishmentRequest as described in 3GPP TS36.331 v14.2.1) of the procedure used to re-establish a RRC connection if the UE has parameters to be used in RRC_INACTIVE and the UE is in a RAN notification area. The RAN notification area could be derived from parameters or as indicated by the network.

In one embodiment, the UE could include the first identity and not include the second identity in a request message (e.g., RRCConnectionReestablishmentRequest as described in 3GPP TS36.331 v14.2.1) of the procedure used to re-establish a RRC connection if the UE has no parameters to be used in RRC_INACTIVE or has invalid parameters.

In one embodiment, the UE could include the first identity and not include the second identity in a request message (e.g., RRCConnectionReestablishmentRequest as described in 3GPP TS36.331 v14.2.1) of the procedure used to re-establish a RRC connection if the UE is not in a RAN notification area. The RAN notification area could be derived from configured parameters to be used in RRC_INACTIVE or as indicated by the network.

In one embodiment, the UE could include the first identity and not include the second identity in a request message (e.g., RRCConnectionReestablishmentRequest as described in 3GPP TS36.331 v14.2.1) of the procedure used to re-establish a RRC connection if the UE has parameters to be used in RRC_INACTIVE, but the UE is not in a RAN notification area. The RAN notification area could be derived from parameters or indicated by the network.

With the first identity included in a request message of a procedure used to re-establish a RRC connection, if the network or a prepared cell controlled by the network is able to distinguish the first identity, the network or the prepared cell control by the network can respond to the UE with a RRC re-establishment message (e.g., RRCConnectionReestablishment as described in 3GPP TS36.331 v14.2.1) in response to the request message.

With the second identity included in the request message of the procedure used to re-establish a RRC connection, the network will retrieve UE information from an anchor node (i.e., a gNB which stores the UE information) based on the second identity. If retrieving the UE information is successful, the network can respond to the UE with a RRC resume message (e.g., RRCConnectionResume as described in 3GPP TS36.331 v14.2.1). The network could retrieve or start to retrieve the UE information from the anchor node if the first identity is not distinguishable or retrieve the UE information upon the reception of the second identity. If the first identity is distinguishable and retrieval of the UE information is successful, the network can respond to the UE with either the RRC re-establishment message or the RRC resume message. In this alternative, the UE does not additionally perform a procedure used to resume a RRC connection, which reduces signaling overhead and delay.

If the procedure used to re-establish a RRC connection has failed and the request message of this procedure includes the first identity and the second identity, the UE could enter into RRC_INACTIVE or RRC_IDLE. The UE could enter (and remain in) RRC_INACTIVE if the UE has the parameters to be used in RRC_INACTIVE. Alternatively, the UE could enter RRC_IDLE if the UE does not have the parameters to be used in RRC_INACTIVE.

The UE in RRC_INACTIVE may perform a procedure used to resume a RRC connection if the UE enters RRC_INACTIVE in normal cases (e.g., via an indication indicating to enter RRC_INACTIVE or expiration of a specific timer controlling the timing to enter RRC_INACTIVE), a request message of the procedure used to resume a RRC connection includes the second identity and does not include the first identity.

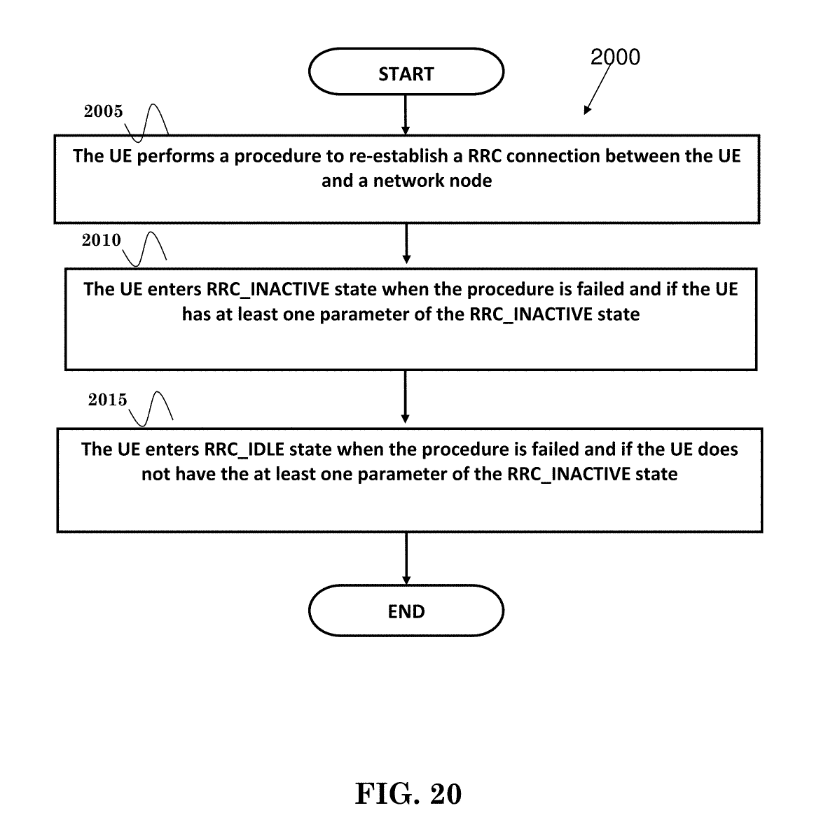

FIG. 20 is a flow chart 2000 according to one exemplary embodiment from the perspective of a UE. In step 2005, the UE performs a procedure used to re-establish a RRC connection between the UE and a network node. In step 2010, the UE enters RRC_INACTIVE state when the procedure is failed and if the UE has at least one parameter of the RRC_INACTIVE state. In step 2015, the UE enters RRC_IDLE state when the procedure is failed and if the UE does not have the at least one parameter of the RRC_INACTIVE state.

According to one exemplary method of a UE, the method includes: performing a procedure used to re-establish RRC connection; entering RRC_INACTIVE when the procedure is failed and if the UE has configuration of RRC_INACTIVE; and entering RRC_IDLE when the procedure is failed and if the UE has no configuration of RRC_INACTIVE.

In one exemplary method, the method further includes: performing, by the UE, the procedure due to handover failure or radio link failure.

In another exemplary method, the UE is in RRC_CONNECTED when performing the procedure.

In another exemplary method, the UE is in a RAN notification area.

According to one exemplary method of a UE, the method includes: performing a procedure to re-establish a RRC connection between the UE and a network node; including a first identity and a second identity in a request message of the procedure if the UE has configuration of RRC_INACTIVE, wherein the first identity is used to re-establish the RRC connection and the second identity is used to resume the RRC connection; including the first identity and not including the second identity in the request message if the UE has no configuration of RRC_INACTIVE; and transmitting the request message to the network node.

In one exemplary method, the first identity is ReestabUE-Identity. In one exemplary method, the second identity is resumeIdentity. In another exemplary method, the request message is RRCConnectionReestablishmentRequest.

In one or more of the above disclosed methods, the configuration of RRC_INACTIVE is provided by the network node via a dedicated signalling sent to the UE.

In one or more of the above disclosed methods, the configuration of RRC_INACTIVE includes parameters (to be) used in RRC_INACTIVE.

In one or more of the above disclosed methods, the network node is a base station such as, but not limited to, a gNB.

According to one exemplary method of a UE, the method includes: performing a procedure used to re-establish a RRC connection between the UE and a network node; entering RRC_INACTIVE state when the procedure is failed and if the UE has at least one parameter of the RRC_INACTIVE state; and entering RRC_IDLE state when the procedure is failed and if the UE does not have the at least one parameter of the RRC_INACTIVE state.

In one exemplary method, the UE is in RRC_CONNECTED state when performing the procedure.

In one exemplary method, the UE performs the procedure due to handover failure or radio link failure.

In one exemplary method, the method further includes the UE receiving a reject message of the procedure from the network node. In another method, the reject message indicates the UE to enter the RRC INACTIVE state or the RRC_IDLE state.

In one or more of the above disclosed methods, the procedure is failed because the UE receives the reject message.

In one or more of the above disclosed methods, the at least one parameter of the RRC_INACTIVE state is included in the reject message.

In one or more of the above disclosed methods, the UE receives the at least one parameter of the RRC_INACTIVE state in a RRC (connection) reconfiguration message (when the UE is in RRC_CONNECTED state).

In one or more of the above disclosed methods, the at least one parameter includes an identity to be used to resume the RRC connection. In one or more of the above disclosed methods, the at least one parameter is used by the UE when the UE is in the RRC_INACTIVE state.

In one or more of the above disclosed methods, the UE is in a Radio Access Network (RAN) notification area derived from the at least one parameter of the RRC_INACTIVE state

Referring back to FIGS. 3 and 4, in one embodiment, the device 300 includes a program code 312 stored in memory 310. The CPU 308 could execute program code 312 to enable the network (i) to perform a procedure used to re-establish a RRC connection between the UE and a network node; (ii) to enter RRC_INACTIVE state when the procedure is failed and if the UE has at least one parameter of the RRC_INACTIVE state; and (iii) to enter RRC_IDLE state when the procedure is failed and if the UE does not have the at least one parameter of the RRC_INACTIVE state.

Furthermore, the CPU 308 can execute the program code 312 to perform all of the above-described actions and steps or others methods described herein.

Based on above-disclosed methods, system information requests and responses can be more resource efficient. Additionally, unnecessary transmissions of system information requests can be reduced.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a user equipment (UE), the method comprising:
performing a procedure used to re-establish a RRC connection between the UE and a network node;
entering RRC_INACTIVE state when the procedure is failed and if the UE has at least one parameter of the RRC_INACTIVE state; and
entering RRC_IDLE state when the procedure is failed and if the UE does not have the at least one parameter of the RRC_INACTIVE state.

2. The method of claim 1, wherein the UE is in RRC_CONNECTED state when performing the procedure.

3. The method of claim 1, wherein the UE performs the procedure due to handover failure or radio link failure.

4. The method of claim 1, further comprising: receiving a reject message of the procedure from the network node.

5. The method of claim 4, wherein the at least one parameter of the RRC_INACTIVE state is included in the reject message.

6. The method of claim 4, wherein the reject message indicates the UE to enter the RRC_INACTIVE state or the RRC_IDLE state.

7. The method of claim 4, wherein the procedure is failed because the UE receives the reject message.

8. The method of claim 1, wherein the UE receives the at least one parameter of the RRC_INACTIVE state in a RRC reconfiguration message.

9. The method of claim 1, wherein the at least one parameter includes an identity to be used to resume the RRC connection.

10. The method of claim 1, wherein the UE is in a Radio Access Network (RAN) notification area derived from the at least one parameter of the RRC_INACTIVE state.

11. A User Equipment (UE), comprising:
a control circuit;
a processor installed in the control circuit; and
a memory installed in the control circuit and coupled to the processor;
wherein the processor is configured to execute a program code stored in the memory to:
perform a procedure used to re-establish a RRC connection between the UE and a network node;
enter RRC_INACTIVE state when the procedure is failed and if the UE has at least one parameter of the RRC_INACTIVE state; and
enter RRC_IDLE state when the procedure is failed and if the UE does not have the at least one parameter of the RRC_INACTIVE state.

12. The UE of claim 11, wherein the UE is in RRC_CONNECTED state when performing the procedure.

13. The UE of claim 11, wherein the UE performs the procedure due to handover failure or radio link failure.

14. The UE of claim 11, wherein the processor is further configured to receive a reject message of the procedure from the network node.

15. The UE of claim 14, wherein the at least one parameter of the RRC_INACTIVE state is included in the reject message.

16. The UE of claim 14, wherein the reject message indicates the UE to enter the RRC_INACTIVE state or the RRC_IDLE state.

17. The UE of claim 14, wherein the procedure is failed because the UE receives the reject message.

18. The UE of claim 11, wherein the UE receives the at least one parameter of the RRC_INACTIVE state in a RRC reconfiguration message.

19. The UE of claim 11, wherein the at least one parameter includes an identity to be used to resume the RRC connection.

20. The UE of claim 11, wherein the UE is in a Radio Access Network (RAN) notification area derived from the at least one parameter of the RRC_INACTIVE state.
